(19) United States
(12) Patent Application Publication
(10) Pub. No.: US 2024/0405833 A1
(43) Pub. Date: Dec. 5, 2024

(54) UPLINK CODEBOOK AND SIGNALING DESIGN

(71) Applicant: QUALCOMM Incorporated, San Diego, CA (US)

(72) Inventors: Hyojin LEE, San Diego, CA (US); Yu ZHANG, San Diego, CA (US); Kexin XIAO, Shanghai (CN); Yi HUANG, San Diego, CA (US)

(21) Appl. No.: 18/691,632

(22) PCT Filed: Nov. 8, 2021
(86) PCT No.: PCT/CN2021/129292

§ 371 Date: Mar. 13, 2024

(51) Int. Cl. H04B 7/06; H04B 7/0456; H04L 5/00

(52) U.S. Cl. CPC H04B 7/0639; H04B 7/0469; H04B 7/0486; H04B 7/063; H04L 5/0048

(57) ABSTRACT

Methods, systems, and devices for wireless communication are described. A user equipment (UE) may transmit, from a UE to a base station, one or more reference signals over a channel. The UE may receive, from the base station based at least in part on transmitting the one or more reference signals, control signaling indicating a precoding matrix indicator (PMI) and a rank indicator (RI) based at least in part on the UE having at least eight transmit antennas and based at least in part on a phase difference between different subsets of transmit antennas of the at least eight transmit antennas. The UE may transmit, to the base station, an uplink transmission configured according to the PMI and the RI.

### CROSS REFERENCE

The present Application is a 371 national stage filing of International PCT Application No. PCT/CN2021/129292 by LEE et al. entitled “UPLINK CODEBOOK AND SIGNALING DESIGN,” filed Nov. 8, 2021, which is assigned to the assignee hereof, and which is expressly incorporated by reference in its entirety herein.

### TECHNICAL FIELD

The following relates to wireless communication, including uplink codebook-based precoding by a user equipment having an advanced configuration of transmit antennas.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include base station(s) or network access node(s), each simultaneously supporting communication for multiple communication devices, which may be otherwise known as user equipment (UE).

Some advanced UEs may be equipped with eight (or more) transmit antennas available for performing transmissions, such as uplink transmissions to a base station. Moreover, the transmit antennas on the UE, unlike antennas of the base station, may be installed or configured such that different subsets of the transmit antennas are not cross-polarized. Downlink codebook designs being used by base stations to map information bits to physical resources are generally configured based on the cross-polarization design of the base station's transmit antennas. Codebook designs being used by UEs to map information bits to physical resources for transmission also rely on such downlink codebook designs, which may not be configured to efficiently and effectively utilize the eight transmit antennas, which may be co-polarized or otherwise have a different phase relationship than the base station antennas.

### SUMMARY

The systems, methods and devices of this disclosure each have several innovative aspects, no single one of which is solely responsible for the desirable attributes disclosed herein.

One innovative aspects of the subject matter described in this disclosure can be implemented in a method for wireless communications at a user equipment (UE). The method may include transmitting, to a base station, one or more reference signals over a channel, receiving, from the base station based on transmitting the one or more reference signals, control signaling indicating a precoding matrix indicator (PMI) and a rank indicator (RI), the PMI and the RI being based on the UE having at least eight transmit antennas and based on a phase difference between different subsets of transmit antennas of the at least eight transmit antennas, and transmitting, to the base station, an uplink transmission configured according to the PMI and the RI.

Another innovative aspects of the subject matter described in this disclosure can be implemented in an apparatus for wireless communications at a UE. The apparatus may include a processor, memory coupled with the processor, and instructions stored in the memory. The instructions may be executable by the processor to cause the apparatus to transmit, to a base station, one or more reference signals over a channel, receive, from the base station based on transmitting the one or more reference signals, control signaling indicating a PMI and a RI, the PMI and the RI being based on the UE having at least eight transmit antennas and based on a phase difference between different subsets of transmit antennas of the at least eight transmit antennas, and transmit, to the base station, an uplink transmission configured according to the PMI and the RI.

Another innovative aspects of the subject matter described in this disclosure can be implemented in an apparatus for wireless communications at a UE. The apparatus may include means for transmitting, to a base station, one or more reference signals over a channel, means for receiving, from the base station based on transmitting the one or more reference signals, control signaling indicating a PMI and a RI, the PMI and the RI being based on the UE having at least eight transmit antennas and based on a phase difference between different subsets of transmit antennas of the at least eight transmit antennas, and means for transmitting, to the base station, an uplink transmission configured according to the PMI and the RI.

Another innovative aspects of the subject matter described in this disclosure can be implemented in a non-transitory computer-readable medium storing code for wireless communications at a UE. The code may include instructions executable by a processor to transmit, to a base station, one or more reference signals over a channel, receive, from the base station based on transmitting the one or more reference signals, control signaling indicating a PMI and a RI, the PMI and the RI being based on the UE having at least eight transmit antennas and based on a phase difference between different subsets of transmit antennas of the at least eight transmit antennas, and transmit, to the base station, an uplink transmission configured according to the PMI and the RI.

Another innovative aspects of the subject matter described in this disclosure can be implemented in a method for wireless communications at a base station. The method may include selecting, based on one or more reference signals received from a UE, a PMI and a RI, the PMI and the RI being based on the UE having at least eight transmit antennas and based on a phase difference between different subsets of transmit antennas of the at least eight transmit antennas, transmitting, to the UE, control signaling indicating the PMI and the RI, and receiving, from the UE, an uplink transmission configured based on the PMI and the RI.

Another innovative aspects of the subject matter described in this disclosure can be implemented in an apparatus for wireless communications at a base station. The apparatus may include a processor, memory coupled with the processor, and instructions stored in the memory. The instructions may be executable by the processor to cause the apparatus to select, based on one or more reference signals received from a UE, a PMI and a RI, the PMI and the RI being based on the UE having at least eight transmit antennas and based on a phase difference between different subsets of transmit antennas of the at least eight transmit antennas, transmit, to the UE, control signaling indicating the PMI and the RI, and receive, from the UE, an uplink transmission configured based on the PMI and the RI.

Another innovative aspects of the subject matter described in this disclosure can be implemented in an apparatus for wireless communications at a base station. The apparatus may include means for selecting, based on one or more reference signals received from a UE, a PMI and a RI, the PMI and the RI being based on the UE having at least eight transmit antennas and based on a phase difference between different subsets of transmit antennas of the at least eight transmit antennas, means for transmitting, to the UE, control signaling indicating the PMI and the RI, and means for receiving, from the UE, an uplink transmission configured based on the PMI and the RI.

Another innovative aspects of the subject matter described in this disclosure can be implemented in a non-transitory computer-readable medium storing code for wireless communication at a base station is described. The code may include instructions executable by a processor to select, based on one or more reference signals received from a UE, a PMI and a RI, the PMI and the RI being based on the UE having at least eight transmit antennas and based on a phase difference between different subsets of transmit antennas of the at least eight transmit antennas, transmit, to the UE, control signaling indicating the PMI and the RI, and receive, from the UE, an uplink transmission configured based on the PMI and the RI.

### BRIEF DESCRIPTION OF THE DRAWINGS

FIG. 1 illustrates an example of a wireless communications system that supports uplink codebook-based precoding by a user equipment (UE) having an advanced configuration of transmit antennas in accordance with aspects of the present disclosure.

FIG. 2 illustrates an example of a wireless communications system that supports uplink codebook-based precoding by a UE having an advanced configuration of transmit antennas in accordance with aspects of the present disclosure.

FIG. 3 illustrates an example of a process that supports uplink codebook-based precoding by a UE having an advanced configuration of transmit antennas in accordance with aspects of the present disclosure.

FIGS. 4 and 5 show block diagrams of devices that support uplink codebook-based precoding by a UE having an advanced configuration of transmit antennas in accordance with aspects of the present disclosure.

FIG. 6 shows a block diagram of a communications manager that supports uplink codebook-based precoding by a UE having an advanced configuration of transmit antennas in accordance with aspects of the present disclosure.

FIG. 7 shows a diagram of a system including a device that supports uplink codebook-based precoding by a UE having an advanced configuration of transmit antennas in accordance with aspects of the present disclosure.

FIGS. 8 and 9 show block diagrams of devices that support uplink codebook-based precoding by a UE having an advanced configuration of transmit antennas in accordance with aspects of the present disclosure.

FIG. 10 shows a block diagram of a communications manager that supports uplink codebook-based precoding by a UE having an advanced configuration of transmit antennas in accordance with aspects of the present disclosure.

FIG. 11 shows a diagram of a system including a device that supports uplink codebook-based precoding by a UE having an advanced configuration of transmit antennas in accordance with aspects of the present disclosure.

FIGS. 12-16 show flowcharts illustrating methods that support uplink codebook-based precoding by a UE having an advanced configuration of transmit antennas in accordance with aspects of the present disclosure.

### DETAILED DESCRIPTION

Various aspects generally relate to precoding, and more specifically, to uplink codebook design for a user equipment (UE) having an advanced UE configuration, such as eight (or more) transmit antennas. In some examples, different subsets of the transmit antennas may be co-polarized, or may otherwise not be cross-polarized. That is, the eight (or more) transmit antennas of the UE may be configured such that the different subsets of the transmit antennas have a phase relationship that satisfies a threshold. In some such examples, the UE may transmit reference signal(s) to a base station, which may receive the reference signals and perform various measurements of the channel between the UE and the base station. The base station may then determine a precoding matrix indicator (PMI) and a rank indicator (RI) for the UE to use for uplink transmissions based on the measurements as well as based on the advanced UE configuration. The UE may then perform uplink transmissions to the base station according to the PMI and the RI.

Particular aspects of the subject matter described in this disclosure may be implemented to realize at least the following potential advantages. The advanced uplink codebook design may provide benefits and enhancements to uplink transmission performance, including improved mapping of information to physical resources for uplink transmissions by the UE, based on an advanced configuration of a UE having eight (or more) transmit antennas, where the phase relationship between different subsets of the eight (or more) transmit antennas improves one or both of PMI or RI selection for the uplink transmissions.

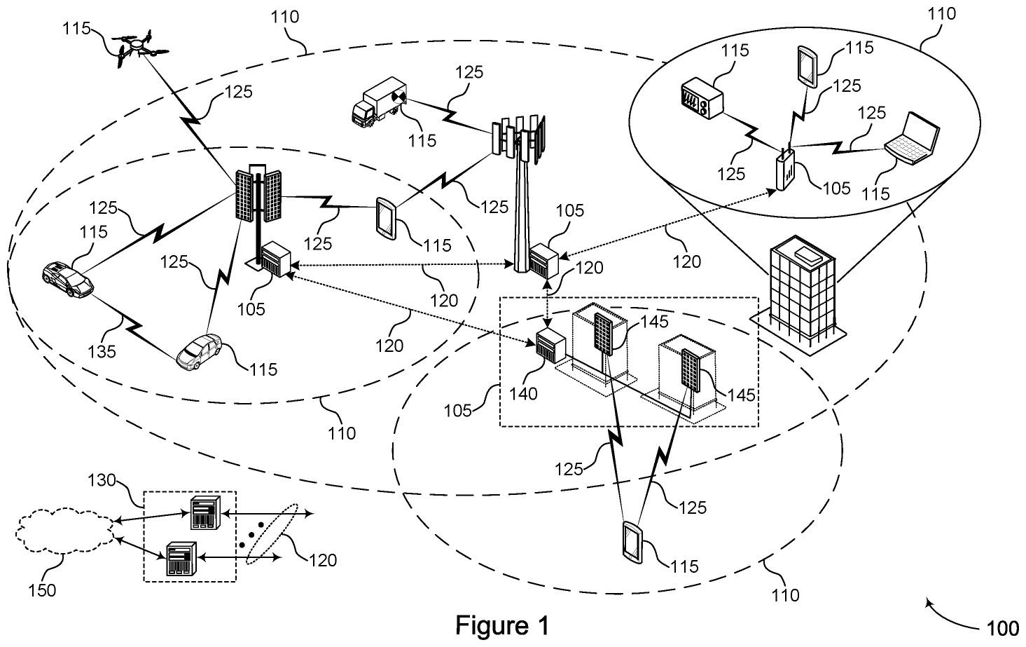

FIG. 1 illustrates an example of a wireless communications system 100 that supports uplink codebook-based precoding by a UE having an advanced configuration of transmit antennas in accordance with aspects of the present disclosure. The wireless communications system 100 may include base station(s) 105, UE(s) 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via communication links 125. Each base station 105 may provide a coverage area 110 over which the UEs 115 and the base station 105 may establish communication links 125. The coverage area 110 may be an example of a geographic area over which a base station 105 and a UE 115 may support the communication of signals according to radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (for example core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through backhaul links 120 (for example via an S1, N2, N3, or other interface). The base stations 105 may communicate with one another over the backhaul links 120 (for example via an X2, Xn, or other interface) either directly (for example directly between base stations 105), or indirectly (for example via core network 130), or both. In some examples, the backhaul links 120 may be or include wireless link(s).

The base station(s) 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, such that the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via communication links 125 over carrier(s). The term “carrier” may refer to a set of radio frequency spectrum resources having a defined physical layer structure for supporting the communication links 125. For example, a carrier used for a communication link 125 may include a portion of a radio frequency spectrum band (for example a bandwidth part (BWP)) that is operated according to physical layer channel(s) for a given radio access technology (for example LTE, LTE-A, LTE-A Pro, NR). Each physical layer channel may carry acquisition signaling (for example synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and uplink component carrier(s) according to a carrier aggregation configuration. Carrier aggregation may be used with both frequency division duplexing (FDD) and time division duplexing (TDD) component carriers.

In some examples (for example in a carrier aggregation configuration), a carrier may also have acquisition signaling or control signaling that coordinates operations for other carriers. A carrier may be associated with a frequency channel (for example an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode such that initial acquisition and connection may be conducted by the UEs 115 via the carrier, or the carrier may be operated in a non-standalone mode such that a connection is anchored using a different carrier (for example of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (for example in an FDD mode) or may be configured to carry downlink and uplink communications (for example in a TDD mode).

A carrier may be associated with a particular bandwidth of the radio frequency spectrum, and examples the carrier bandwidth may be referred to as a “system bandwidth” of the carrier or the wireless communications system 100. For example, the carrier bandwidth may be one of a number of determined bandwidths for carriers of a particular radio access technology (for example 1.4, 3, 5, 10, 15, 20, 40, or 80 megahertz (MHz)). Devices of the wireless communications system 100 (for example the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (for example a sub-band, a BWP) or all of a carrier bandwidth.

Signal waveforms transmitted over a carrier may be made up of multiple subcarriers (for example using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (for example a duration of one modulation symbol) and one subcarrier, the symbol period and subcarrier spacing are inversely related. The number of bits carried by each resource element may depend on the modulation scheme (for example the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (for example spatial layers or beams), and the use of multiple spatial layers may further increase the data rate or data integrity for communications with a UE 115.

Numerologies for a carrier may be supported, a numerology may include a subcarrier spacing (Δf) and a cyclic prefix. A carrier may be divided into BWP(s) having the same or different numerologies. In some examples, a UE 115 may be configured with multiple BWPs. In some examples, a single BWP for a carrier may be active at a given time and communications for the UE 115 may be restricted to active BWP(s).

The time intervals for the base stations 105 or the UEs 115 may be expressed in multiples of a basic time unit which may, for example, refer to a sampling period of Tₛ=1/(Δfₘₐₓ·N_{f}) seconds, Δfₘₐₓ may represent the maximum supported subcarrier spacing, and N_{f} may represent the maximum supported discrete Fourier transform (DFT) size. Time intervals of a communications resource may be organized according to radio frames each having a specified duration (for example 10 milliseconds (ms)). Each radio frame may be identified by a system frame number (SFN) (for example ranging from 0 to 1023).

Each frame may include multiple consecutively numbered subframes or slots, and each subframe or slot may have the same duration. In some examples, a frame may be divided (for example in the time domain) into subframes, and each subframe may be further divided into a number of slots. Alternatively, each frame may include a variable number of slots, and the number of slots may depend on subcarrier spacing. Each slot may include a number of symbol periods (for example depending on the length of the cyclic prefix prepended to each symbol period). In some wireless communications systems 100, a slot may further be divided into multiple mini-slots containing symbol(s). Excluding the cyclic prefix, each symbol period may contain sampling period(s) (for example N_{f}). The duration of a symbol period may depend on the subcarrier spacing or frequency band of operation.

A subframe, a slot, a mini-slot, or a symbol may be the smallest scheduling unit (for example in the time domain) of the wireless communications system 100 and may be referred to as a transmission time interval (TTI). In some examples, the TTI duration (for example the number of symbol periods in a TTI) may be variable. Additionally or alternatively, the smallest scheduling unit of the wireless communications system 100 may be dynamically selected (for example in bursts of shortened TTIs (sTTIs)).

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. A control region (for example a control resource set (CORESET)) for a physical control channel may be defined by a number of symbol periods and may extend across the system bandwidth or a subset of the system bandwidth of the carrier. Control region(s) (for example CORESETs) may be configured for a set of the UEs 115. For example, the UE(s) 115 may monitor or search control regions for control information according to search space set(s), and each search space set may include one or multiple control channel candidates in aggregation levels arranged in a cascaded manner. An aggregation level for a control channel candidate may refer to a number of control channel resources (for example control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via cell(s), for example a macro cell, a small cell, a hot spot, or other types of cells, or any combination thereof. The term “cell” may refer to a logical communication entity used for communication with a base station 105 (for example over a carrier) and may be associated with an identifier for distinguishing neighboring cells (for example a physical cell identifier (PCID), a virtual cell identifier (VCID), or others). In some examples, a cell may also refer to a geographic coverage area 110 or a portion of a geographic coverage area 110 (for example a sector) over which the logical communication entity operates. Such cells may range from smaller areas (for example a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (for example several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (for example licensed, unlicensed) frequency bands as macro cells. Small cells may provide unrestricted access to the UEs 115 with service subscriptions with the network provider or may provide restricted access to the UEs 115 having an association with the small cell (for example the UEs 115 in a closed subscriber group (CSG), the UEs 115 associated with users in a home or office). A base station 105 may support one or multiple cells and may also support communications over the cell(s) using one or multiple component carriers.

In some examples, a carrier may support multiple cells, and different cells may be configured according to different protocol types (for example MTC, narrowband IoT (NB-IoT), enhanced mobile broadband (eMBB)) that may provide access for different types of devices.

In some examples, a base station 105 may be movable and provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may not be aligned in time. The techniques described herein may be used for either synchronous or asynchronous operations.

Some UEs 115, such as MTC or IoT devices, may be low cost or low complexity devices and may provide for automated communication between machines (for example via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (for example a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (for example according to narrowband communications), or a combination of these techniques. For example, some UEs 115 may be configured for operation using a narrowband protocol type that is associated with a defined portion or range (for example set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (for example using a peer-to-peer (P2P) or D2D protocol). The UE(s) 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (for example UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via network node(s) (for example base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include a control plane entity that manages access and mobility (for example a mobility management entity (MME), an access and mobility management function (AMF)) and a user plane entity that routes packets or interconnects to external networks (for example a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for network operator(s). The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through other access network transmission entities 145, which may be referred to as radio heads, smart radio heads, or transmission/reception points (TRPs). Each access network transmission entity 145 may include antenna panel(s). In some configurations, various functions of each access network entity 140 or base station 105 may be distributed across various network devices (for example radio heads and ANCs) or consolidated into a single network device (for example a base station 105).

The wireless communications system 100 may operate using frequency band(s), typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (for example less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (for example from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (for example LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within antenna array(s) or antenna panels, which may support MIMO operations or transmit or receive beamforming. For example, base station antenna(s) or antenna array(s) may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have antenna array(s) that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (for example the same codeword) or different data streams (for example different codewords). Different spatial layers may be associated with different antenna ports used for channel measurement and reporting. MIMO techniques include single-user MIMO (SU-MIMO), in which multiple spatial layers are transmitted to the same receiving device, and multiple-user MIMO (MU-MIMO), in which multiple spatial layers are transmitted to multiple devices.

Beamforming, which may also be referred to as spatial filtering, directional transmission, or directional reception, is a signal processing technique that may be used at a transmitting device or a receiving device (for example a base station 105, a UE 115) to shape or steer an antenna beam (for example a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (for example antenna panels) to conduct beamforming operations for directional communications with a UE 115. Some signals (for example synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (for example by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (for example a direction associated with the receiving device, such as a UE 115). In some examples, the beam direction associated with transmissions along a single beam direction may be determined based on a signal that was transmitted in beam direction(s). For example, a UE 115 may receive the signal(s) transmitted by the base station 105 in different directions and may report to the base station 105 an indication of the signal that the UE 115 received with a highest signal quality or an otherwise acceptable signal quality.

In some examples, transmissions by a device (for example by a base station 105 or a UE 115) may be performed using multiple beam directions, and the device may use a combination of digital precoding or radio frequency beamforming to generate a combined beam for transmission (for example from a base station 105 to a UE 115). The UE 115 may report feedback that indicates precoding weights for beam direction(s), and the feedback may correspond to a configured number of beams across a system bandwidth or sub-band(s). The base station 105 may transmit a reference signal (for example a cell-specific reference signal (CRS), a channel state information reference signal (CSI-RS)), which may be precoded or unprecoded. The UE 115 may provide feedback for beam selection, which may be a PMI or codebook-based feedback (for example a multi-panel type codebook, a linear combination type codebook, a port selection type codebook). Although these techniques are described with reference to signals transmitted in direction(s) by a base station 105, a UE 115 may employ similar techniques for transmitting signals multiple times in different directions (for example for identifying a beam direction for subsequent transmission or reception by the UE 115) or for transmitting a signal in a single direction (for example for transmitting data to a receiving device).

A receiving device (for example a UE 115) may try multiple receive configurations (for example directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (for example different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (for example when receiving a data signal). The single receive configuration may be aligned in a beam direction determined based on listening according to different receive configuration directions (for example a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (for example using a cyclic redundancy check (CRC)), forward error correction (FEC), and retransmission (for example automatic repeat request (ARQ)). HARQ may improve throughput at the MAC layer in poor radio conditions (for example low signal-to-noise conditions). In some examples, a device may support same-slot HARQ feedback, in which the device may provide HARQ feedback in a specific slot for data received in a previous symbol in the slot. In other cases, the device may provide HARQ feedback in a subsequent slot, or according to some other time interval.

A UE 115 may transmit, to a base station 105, reference signal(s) over a channel. The UE 115 may receive, from the base station 105 based at least in part on transmitting the reference signal(s), control signaling indicating a PMI and a RI, the PMI and the RI being based at least in part on the UE 115 having at least eight transmit antennas and based at least in part on a phase difference between different subsets of transmit antennas of the at least eight transmit antennas. The UE 115 may transmit, to the base station 105, an uplink transmission configured according to the PMI and the RI. In some aspects, the UE 115 may perform the uplink transmission using one or more subsets of the eight (or more) transmit antennas according to the PMI and the RI.

A base station 105 may select, based at least in part on reference signal(s) received from a UE 115, a PMI and a RI, the PMI and the RI being based at least in part on the UE 115 having at least eight transmit antennas and based at least in part on a phase difference between different subsets of transmit antennas of the at least eight transmit antennas. The base station 105 may transmit, to the UE 115, control signaling indicating the PMI and the RI. The base station 105 may receive, from the UE 115, an uplink transmission configured based at least in part on the PMI and the RI.

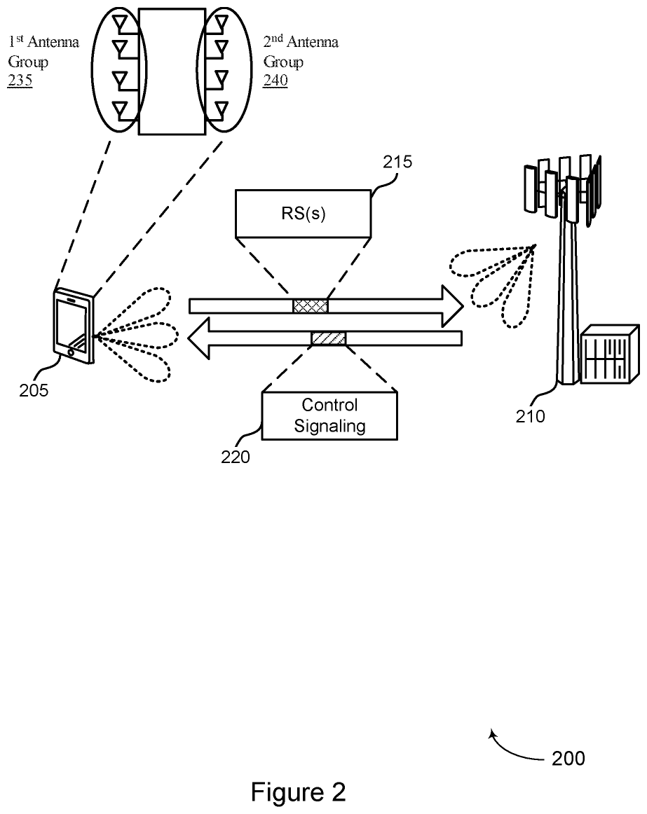

FIG. 2 illustrates an example of a wireless communications system 200 that supports uplink codebook-based precoding by a UE having an advanced configuration of transmit antennas in accordance with aspects of the present disclosure. The wireless communications system 200 may include a UE 205 or a base station 210, which may be examples of the corresponding devices described herein.

The UE 205 and the base station 210 may use codebooks in configuring downlink communications. Broadly, the codebook may include a matrix of complex values used to map data bits to antenna ports (for example map data bits to physical resources). This may include a type I codebook which uses a series of defined matrices or a type II codebook which uses mathematical formulas based on a series of parameters. The parameters may be based on RRC configuration signaling and UE reporting (for example CSI-RS reporting). The type II codebook may be used to select, identify, or otherwise determine the PMI and RI, for the downlink transmission. For example, this may include DFT-based W1W2 codebooks that have been designated for downlink communications from the base station 210 to the UE 205. UE 205, knowing the PMI and RI for the downlink transmission may determine one or more locations in which to look (for example within the physical resources) for the data in the downlink transmission.

However, such DFT-based codebooks were designed in consideration of the base station 210 having a uniform or rectangular antenna structure, which includes cross-polarization between antenna(s) of the base station 210. Such codebook design techniques may be ineffective for other antenna configurations. For example, advanced UEs, such as the UE 205, may be configured with more than four antennas, and may have more relaxed power constraints. That is, the UE 205 may have different antenna structures than the base station 210 (for example the UE 205 may have non-uniform antenna spacing and the antennas may be co-polarized (without cross-polarization). It may be beneficial for an uplink codebook design that supports the antenna array structure of the UE 205, such as in examples in which the UE 205 has more than eight antennas. In some examples, this may include leveraging that a downlink 4Tx Householder codebook provides performance increased than a DFT-based codebook, particularly in the situation in which the antenna array structure of the UE 205 has non-uniform antenna spacing. In some examples, the uplink codebook design described herein may include a precoding matrix with elements {+1, −1, j, −j}.

Aspects of the techniques described herein provide for the base station 210 to configure the UE 205 with a PMI/RI that is based, at least to some degree, on the UE 205 having at least eight transmit antennas, and on the phase difference between different subsets of transmit antennas of the at least eight transmit antennas. Broadly, this may include the UE 205 transmitting or otherwise providing (and the base station 210 receiving or otherwise obtaining) reference signal(s) 215 (for example sounding RS) over a channel. The reference signal(s) 215 may be transmitted or otherwise provided via beamformed or directional transmissions (for example each reference signal transmission may use a different transmit beam configuration of the UE 205). The base station 210 may receive the reference signal(s) 215 and identify, select, or otherwise determine a PMI and RI for the UE 205 based, at least to some degree, on the UE 205 having the at least eight transmit antennas. For example, the base station 210 may select, identify, or otherwise determine the PMI/RI for the UE 205 to use for an uplink transmission using a 8Tx codebook design (for example based on the UE 205 having the eight transmit antennas). In some examples, this may include the base station 210 using an 8×8 Householder matrix, using a pair (or more) 4×4 Householder matrices (in examples in which the eight transmit antennas of the UE 205 are divided into different subsets (such as a first antenna group 235 and a second antenna group 240).

More particularly, the base station 210 may receive the reference signal(s) 215 transmitted from the UE 205 and measure or otherwise process the reference signal(s) 215 to determine channel performance characteristics (for example channel state information (CSI)) for the channel between the base station 210 and the UE 205. The base station 210 may use the channel performance characteristics, phase difference between different subsets of the eight transmit antennas of the UE 205, and the Householder matrix to select a precoding matrix or RI for the UE 205 to use for uplink transmissions. The base station 210 may select a precoding matrix (and corresponding PMI, which may also be referred to as a transmit precoding matrix indicator (TPMI)) and RI for the uplink transmissions from the UE 205 in a manner that optimizes uplink transmission performance over the channel.

The base station 210 may transmit or otherwise provide (and the UE 205 may receive or otherwise obtain) control signaling that carries or otherwise conveys an indication of the PMI and RI. The UE 205 may then transmit or otherwise provide (and the base station 210 may receive or otherwise obtain) uplink transmission(s) configured according to the PMI and RI indicated in the control signaling.

The UE 205 or the base station 210 may identify or otherwise determine/use an 8×8 Householder matrix for configuring/performing the uplink transmissions from the UE 205 to the base station 210. In this example, the 8×8 Householder matrix may be configured such that every element is on a fixed phase-shift keying (PSK) constellation is unknown. For example, a rank-1 precoder may be given by: w=1/(2√2) [1, α_1, α_2, . . . , α_7]\hat{ }T, in which α_n=e\hat{ }(j2π(l_n/L)). The Householder vector u satisfies: w=[1, 0, . . . , 0]\hat{ }T−2/(u\hat{ }H u) uu_0\hat{ }*
in which γ is a scalar value. This may result in Equation (1) below:

$${W}_{l} = I - \frac{2}{{u}_{l}^{H} {u}_{l}} {u}_{l} {u}_{l}^{H} = \frac{1}{2 \sqrt{2}} [ \begin{matrix}1 & {α}_{1}^{*} & … & {α}_{7}^{*} \\ {α}_{1} & ( 12 \sqrt{2} - 1 ) / 7 & … & - {α}_{1} {α}_{7}^{*} / ( 2 \sqrt{2} - 1 ) \\ ⋮ & ⋮ & ⋱ & ⋮ \\ {α}_{7} & - {α}_{7} {α}_{1}^{*} / ( 2 \sqrt{2} - 1 ) & ⋯ & ( 12 \sqrt{2} - 1 ) / 7\end{matrix} ]$$

in which each element i is not on the unit circle.

In some aspects, this may include using the 8Tx codebook based on stacking 4×4 Householder matrices. For example, the UE 205 or the base station 210 may, for the uplink transmissions and based on the reference signal(s) 215, select, identify, or otherwise determine a co-phasing parameter for each of the different subsets of the eight transmit antennas (for example determine a first co-phasing parameter for the first antenna group 235 and a second co-phasing parameter for the second antenna group 240). The UE 205 or the base station 210 may select, identify, or otherwise determine a first Householder matrix for the first subset of the eight transmit antennas (for example a first 4×4 Householder matrix) and a second Householder matrix for the second subset of the eight transmit antennas (for example a second 4×4 Householder matrix). The UE 205 or the base station 210 may use the PMI/RI for the uplink transmission based on the co-phasing parameter and the antenna subsets.

More particularly, this may include forming an 8Tx Householder matrix (for example precoding matrix) given by Equation (2) below:

$${W}_{l , m , n}^{r} = \frac{1}{\sqrt{2}} [ \begin{matrix}{[ {H}_{4 , l} ]}^{( r )} \\ {{φ}_{n} [ {H}_{4 , m} ]}^{( r )}\end{matrix} ] ,$$

in which

$${H}_{4 , l} = {I}_{4} - \frac{2}{{u}_{l}^{H} {u}_{l}} {u}_{l} {u}_{l}^{H}$$

and [H_{4,l}]^{(r)} is the 4×r matrix with r columns which are selected from 4 columns of H_{4,l}. The Householder precoding may be performed within an antenna group and based on the co-phasing relationship across different antenna groups. The parameters may include: φₙ=e^{j2πn/N}, n=0, . . . N−1 being the co-phasing parameter, uₗ, l=0, . . . , L−1, may be designed according to: step 1: choose a set of good rank-1 vectors wₗ, l=0, . . . , L−1; step 2: obtain the corresponding Householder vector uₗ to satisfy the 1^{st} column of the Householder matrix is equal to wₗ; step 3: obtain rank-4 codebook with 4×4 Householder matrices with the Householder vectors; and step 4: obtain rank-2 and 3 with column selection.

Another example may include the UE 205 or the base station 210 measuring, selecting, identifying, or otherwise determining per-layer co-phasing parameters for each of the different subsets of the eight transmit antennas (for example a first per-layer co-phasing parameter for the first antenna group 235 and a second per-layer co-phasing parameter for the second antenna group 240). The UE 205 or the base station 210 may identify or otherwise determine a first Householder matrix (for example a first 4×4 Householder matrix) for the first subset of the eight transmit antennas and a second Householder matrix (for example a second 4×4 Householder matrix) for the second subset of the eight transmit antennas. The UE 205 or the base station 210 may use the PMI/RI for the uplink transmission based on the per-layer co-phasing parameter and the antenna subsets.

More particularly, this may include forming the 8Tx Householder matrix (for example codebook) based on the 4×4 Householder matrices. The form of the 8Tx precoding matrix may be given by

$${W}_{l , m , n}^{r} = \frac{1}{\sqrt{2}} [ \begin{matrix} & {[ {H}_{4 , l} ]}^{( r )} \\ {[ {H}_{4 , m} ]}^{( r )} & [ \begin{matrix}{φ}_{{n}_{0}} & ⋯ & 0 \\ & ⋱ & \\ 0 & ⋯ & {φ}_{{n}_{r - 1}}\end{matrix} ]\end{matrix} ] ,$$

in which

$${H}_{4 , l} = {I}_{4} - \frac{2}{{u}_{l}^{H} {u}_{l}} {u}_{l} {u}_{l}^{H}$$

and [H_{4,l}]^{(r)} is the 4×r matrix with r columns which are selected from 4 columns of H_{4,l}. The Householder precoding may be performed within an antenna group (for example within a subset of the eight transmit antennas). The per-layer co-phasing across different antenna groups with an r×r diagonal matrix may be based on

$$[ \begin{matrix}{φ}_{{n}_{0}} & ⋯ & 0 \\ & ⋱ & \\ 0 & ⋯ & {φ}_{{n}_{r - 1}}\end{matrix} ]$$

in which φₙ_{ᵢ}=e^{j2πn}^{ᵢ}^{/N}, nᵢ∈{0, . . . N−1}, i=0, . . . , r−1. The u_l, l=0, . . . , L−1, may be designed using steps 1-4 discussed above.

In some aspects, the design of the 4×4 Householder matrices may include several options.

For example and in a first option, the rank-1 codebook may be based on the Hochwald design using elements {1, −1, j, −j}. Generally, the Hochwald matrix/matrices may be designed to establish (e.g., minimize) the correlation between the different rank-1 precoding matrices. For example, the parameters for the Hochwald design may include: L=16, K=2, q₀=4, q₁=4, resulting in Equation (3) below:

$${w}_{{l}_{0} , {l}_{1}} = \frac{1}{2} [ \begin{matrix}{e}^{j 2 π ( \frac{{a}_{0 , 0}}{{q}_{0}} {l}_{0} + \frac{{a}_{0 , 1}}{{q}_{1}} {l}_{1} )} \\ {e}^{j 2 π ( \frac{{a}_{1 , 0}}{{q}_{0}} {l}_{0} + \frac{{a}_{1 , 1}}{{q}_{1}} {l}_{1} )} \\ ⋮ \\ {e}^{j 2 π ( \frac{{a}_{3 , 0}}{{q}_{0}} {l}_{0} + \frac{{a}_{3 , 1}}{{q}_{1}} {l}_{1} )}\end{matrix} ] , {l}_{1} = 0 , 1 , … , 3 , {l}_{2} = 0 , 1 , … , 3$$

$$A = ( \begin{matrix}{a}_{0 , 0} , {a}_{1 , 0} , {a}_{2 , 0} , {a}_{3 , 0} \\ {a}_{0 , 1} , {a}_{1 , 1} , {a}_{2 , 1} , {a}_{3 , 1}\end{matrix} )$$

may be optimized to minimize the maximum correlation (equivalently to maximize the minimum chordal distance). For example, Equation (4) below:

$${A}^{*} = {min}_{\begin{matrix}0 \leq {a}_{0 , 0} , ⋯ , {a}_{3 , 0} \leq 3 \\ 0 \leq {a}_{0 , 1} , ⋯ , {a}_{3 , 1} \leq 3\end{matrix}} {max}_{( {l}_{0} , {l}_{1} ) = ( 0 , 1 ) , ⋯ , ( 3 , 3 )} \frac{1}{4} \vert {\sum }_{n = 0}^{3} {e}^{j 2 π ( \frac{{a}_{n , 0}}{{q}_{0}} {l}_{0} + \frac{{a}_{n , 1}}{{q}_{1}} {l}_{1} )} \vert ,$$

which may lead to an optimized result:

$${A}^{*} = ( \begin{matrix}0 & 0 & 1 & 3 \\ 0 & 1 & 0 & 3\end{matrix} )$$

(Minmax correlation=0.5000). The rank-1 codebook with the optimized parameters L=16: K=2, q₀=4, q₁=4,

$${A}^{*} = ( \begin{matrix}0 & 0 & 1 & 3 \\ 0 & 1 & 0 & 3\end{matrix} )$$

may result in Table 1 below:

TABLE 1

| | Precoding |
|---|---|
| Index | matrix (wₗ) |
| 0 | ${\frac{1}{2} [ 1 , 1 , 1 , 1 ]}^{T}$ |
| 1 | ${\frac{1}{2} [ 1 , j , 1 , - j ]}^{T}$ |
| 2 | ${\frac{1}{2} [ 1 , - 1 , 1 , - 1 ]}^{T}$ |
| 3 | ${\frac{1}{2} [ 1 , - j , 1 , j ]}^{T}$ |
| 4 | ${\frac{1}{2} [ 1 , 1 , j , - j ]}^{T}$ |
| 5 | ${\frac{1}{2} [ 1 , j , j , - 1 ]}^{T}$ |
| 6 | ${\frac{1}{2} [ 1 , - 1 , j , j ]}^{T}$ |
| 7 | ${\frac{1}{2} [ 1 , - j , j , 1 ]}^{T}$ |
| 8 | ${\frac{1}{2} [ 1 , 1 , - 1 , - 1 ]}^{T}$ |
| 9 | ${\frac{1}{2} [ 1 , j , - 1 , j ]}^{T}$ |
| 10 | ${\frac{1}{2} [ 1 , - 1 , - 1 , 1 ]}^{T}$ |
| 11 | ${\frac{1}{2} [ 1 , - j , - 1 , - j ]}^{T}$ |
| 12 | ${\frac{1}{2} [ 1 , 1 , - j , j ]}^{T}$ |
| 13 | ${\frac{1}{2} [ 1 , j , - j , 1 ]}^{T}$ |
| 14 | ${\frac{1}{2} [ 1 , - 1 , - j , - j ]}^{T}$ |
| 15 | ${\frac{1}{2} [ 1 , - j , - j , 1 ]}^{T}$ |

Table 1 above for the Householder vector uₗ derived to give the optimized rank-1 design may use uₗ that satisfies that

$${w}_{l} = {[ \begin{matrix}1 & 0 & 0 & 0\end{matrix} ]}^{T} - \frac{1}{2} {u}_{l} {u}_{l}^{*} ( 0 ) ,$$

in which uₗ(0) is the first component of uₗ. This may result in Table 2 below:

TABLE 2

| | Householder |
|---|---|
| Index | vector (uₗ) |
| 0 | [1, −1, −1, −1]^{T} |
| 1 | [1, −j, −1, j]^{T} |
| 2 | [1, 1, −1, 1]^{T} |
| 3 | [1, j, −1, −j]^{T} |
| 4 | [1, −1, −j, j]^{T} |
| 5 | [1, −j, −j, 1]^{T} |
| 6 | [1, 1, −j, −j]^{T} |
| 7 | [1, j, −j, −1]^{T} |
| 8 | [1, −1, 1, 1]^{T} |
| 9 | [1, −j, 1, −j]^{T} |
| 10 | [1, 1, 1, −1]^{T} |
| 11 | [1, j, 1, j]^{T} |
| 12 | [1, −1, j, −j]^{T} |
| 13 | [1, −j, j, −1]^{T} |
| 14 | [1, 1, j, j]^{T} |
| 15 | [1, j, j, 1]^{T} |

A 4×4 Householder matrix with quadrature phase-shift keying (QPSK) elements:

$${H}_{4 , l} = {I}_{4} - \frac{2}{{u}_{l}^{H} {u}_{l}} {u}_{l} {u}_{l}^{H}$$

may result in Tables 3 and 4 below:

TABLE 3

| Index | H_{4,l} |
|---|---|
| 0 | $\frac{1}{2} [ \begin{matrix}1 & 1 & 1 & 1 \\ 1 & 1 & - 1 & - 1 \\ 1 & - 1 & 1 & - 1 \\ 1 & - 1 & - 1 & 1\end{matrix} ]$ |
| 1 | $\frac{1}{2} [ \begin{matrix}1 & - j & 1 & j \\ j & 1 & - j & 1 \\ 1 & j & 1 & - j \\ - j & 1 & j & 1\end{matrix} ]$ |
| 4 | $\frac{1}{2} [ \begin{matrix}1 & 1 & - j & j \\ 1 & 1 & j & - j \\ j & - j & 1 & 1 \\ - j & j & 1 & 1\end{matrix} ]$ |
| 5 | $\frac{1}{2} [ \begin{matrix}1 & - j & - j & - 1 \\ j & 1 & - 1 & j \\ j & - 1 & 1 & j \\ - 1 & - j & - j & 1\end{matrix} ]$ |
| 8 | $\frac{1}{2} [ \begin{matrix}1 & 1 & - 1 & - 1 \\ 1 & 1 & 1 & 1 \\ - 1 & 1 & 1 & - 1 \\ - 1 & 1 & - 1 & 1\end{matrix} ]$ |
| 9 | $\frac{1}{2} [ \begin{matrix}1 & - j & - 1 & - j \\ j & 1 & j & - 1 \\ - 1 & - j & 1 & - j \\ j & - 1 & j & 1\end{matrix} ]$ |
| 12 | $\frac{1}{2} [ \begin{matrix}1 & 1 & j & - j \\ 1 & 1 & - j & j \\ - j & j & 1 & 1 \\ j & - j & 1 & 1\end{matrix} ]$ |
| 13 | $\frac{1}{2} [ \begin{matrix}1 & - j & j & 1 \\ j & 1 & 1 & - j \\ - j & 1 & 1 & j \\ 1 & j & - j & 1\end{matrix} ]$ |

TABLE 4

| Index | H_{4,l} |
|---|---|
| 2 | $\frac{1}{2} [ \begin{matrix}1 & - 1 & 1 & - 1 \\ - 1 & 1 & 1 & - 1 \\ 1 & 1 & 1 & 1 \\ - 1 & - 1 & 1 & 1\end{matrix} ]$ |
| 3 | $\frac{1}{2} [ \begin{matrix}1 & j & 1 & - j \\ - j & 1 & j & 1 \\ 1 & - j & 1 & j \\ j & 1 & j & 1\end{matrix} ]$ |
| 6 | $\frac{1}{2} [ \begin{matrix}1 & - 1 & - j & - j \\ - 1 & 1 & - j & - j \\ j & j & 1 & - 1 \\ j & j & - 1 & 1\end{matrix} ]$ |
| 7 | $\frac{1}{2} [ \begin{matrix}1 & j & - j & 1 \\ - j & 1 & 1 & j \\ j & 1 & 1 & - j \\ 1 & - j & j & 1\end{matrix} ]$ |
| 10 | $\frac{1}{2} [ \begin{matrix}1 & - 1 & - 1 & 1 \\ - 1 & 1 & - 1 & 1 \\ - 1 & - 1 & 1 & 1 \\ 1 & 1 & 1 & 1\end{matrix} ]$ |
| 11 | $\frac{1}{2} [ \begin{matrix}1 & j & - 1 & j \\ - j & 1 & - j & - 1 \\ - 1 & j & 1 & j \\ - j & - 1 & - j & 1\end{matrix} ]$ |
| 14 | $\frac{1}{2} [ \begin{matrix}1 & - 1 & j & j \\ - 1 & 1 & j & j \\ - j & - j & 1 & - 1 \\ - j & - j & - 1 & 1\end{matrix} ]$ |
| 15 | $\frac{1}{2} [ \begin{matrix}1 & j & j & - 1 \\ - j & 1 & - 1 & - j \\ - j & - 1 & 1 & - j \\ - 1 & j & j & 1\end{matrix} ]$ |

Another option may include reusing R8 4Tx downlink precoding matrices with elements {1, −1, j, −j}. Setting L=12 with Householder matrices/vectors

$${H}_{4 , I} = {I}_{4} - \frac{2}{{u}_{l}^{H} {u}_{l}} {u}_{l} {u}_{l}^{H}$$

may result in Table 5 below:

TABLE 5

| | Householder |
|---|---|
| Index l | vector (uₗ) |
| 0 | [1, −1, −1, −1]^{T} |
| 1 | [1, −j, 1, j]^{T} |
| 2 | [1, 1, −1, 1]^{T} |
| 3 | [1, j, 1, −j]^{T} |
| 4 | [1, −1, 1, 1]^{T} |
| 5 | [1, −j, −1, −j]^{T} |
| 6 | [1, 1, 1, −1]^{T} |
| 7 | [1, j, −1, j]^{T} |
| 8 | [1, −1, −1, 1]^{T} |
| 9 | [1, −1, 1, −1]^{T} |
| 10 | [1, 1, −1, −1]^{T} |
| 11 | [1, 1, 1, 1]^{T} |

Yet another option may include reusing the R8 4Tx downlink precoding matrix with elements

$$\{ 1 , - 1 , j , - j , \frac{1 + j}{\sqrt{2}} , \frac{- 1 + j}{\sqrt{2}} , \frac{1 - j}{\sqrt{2}} , \frac{- 1 - j}{\sqrt{2}} \} .$$

Setting L=16 with Householder matrices/vectors

$${H}_{4 , l} = {I}_{4} - \frac{2}{{u}_{l}^{H} {u}_{l}} {u}_{l} {u}_{l}^{H}$$

may result in Table 6 below:

TABLE 6

| | Householder |
|---|---|
| Index l | vector (uₗ) |
| 0 | [1, −1, −1, −1]^{T} |
| 1 | [1, −j, 1, j]^{T} |
| 2 | [1, 1, −1, 1]^{T} |
| 3 | [1, j, 1, −j]^{T} |
| 4 | [1, −1, 1, 1]^{T} |
| 5 | [1, −j, −1, −j]^{T} |
| 6 | [1, (−1 − j)/\sqrt{2}, |
| | −j, (1 − j)/\sqrt{2}]^{T} |
| 7 | [1, (1 − j)/\sqrt{2}, j, (−1 − j)/\sqrt{2}]^{T} |
| 8 | [1, (1 + j)/\sqrt{2}, −j, (−1 + j)/\sqrt{2}]^{T} |
| 9 | [1, (−1 + j)/\sqrt{2}, j, (1 + j)/\sqrt{2}]^{T} |
| 10 | [1, 1, 1, −1]^{T} |
| 11 | [1, j, −1, j]^{T} |
| 12 | [1, −1, −1, 1]^{T} |
| 13 | [1, −1, 1, −1]^{T} |
| 14 | [1, 1, −1, −1]^{T} |
| 15 | [1, 1, 1, 1]^{T} |

The PMI/RI for the uplink transmissions from the UE 205 may be selected or otherwise identified based on various aspects of the options/proposals discussed above.

Aspects of the techniques described herein may also include various techniques for designing the control signaling 220 used by the base station 210 to transmit or otherwise convey the PMI/RI information to the UE 205. In some aspects, this may include configuration of a codebook subset restriction (CSR) that may have different alternatives.

A first alternative may include a single codebook designed among non-coherent (NC) (for example CSR1=NC Codebook), partially coherent (PC) (for example CSR2=PC Codebook), and fully coherent (FC) (for example CSR3=FC Codebook). The UE 205 or the base station 210 may identify or otherwise determine a first codebook for the uplink transmissions that includes the first CSR (for example with NC subset(s) of the eight transmit antennas), a second CSR (for example with PC subset(s) of the eight transmit antennas), and a third CSR (for example FC subset(s) of the eight transmit antennas).

For example and for the FC CSR, in examples in which an 8Tx precoding matrices are used (for example as discussed in the first proposal above) in which

$${H}_{4 , l} = {I}_{4} - \frac{2}{{u}_{l}^{H} {u}_{l}} {u}_{l} {u}_{l}^{H}$$

and [H_{4,l}]^{(r)} is the 4×r matrix with r columns which are selected from 4 columns of H_{4,l}, for example based on Equation (5) below:

$${W}_{l , m , n}^{r} = \frac{1}{\sqrt{2}} [ \begin{matrix}{[ {H}_{4 , l} ]}^{( r )} \\ {{φ}_{n} [ {H}_{4 , m} ]}^{( r )}\end{matrix} ]$$

This may result in various control information being indicated for a physical uplink shared channel (PUSCH) transmission (for example the uplink transmission) in control signaling 220. For example, wideband information may be indicated in a first downlink control channel. The wideband information may include the RI (for example using two bits), an upper precoding matrix (PMI_{U}) l: using 4 bits indicating 16 or 12 states, and a lower precoding matrix PMI_{L}) m: using 4 bits indicating 16 or 12 states. The wideband or subband information may be indicated by a second downlink control channel, such as the co-phasing index n: using 2 bits (for example for QPSK) or 3 bits (for example for 8PSK) for each wide/subband. The first downlink control channel may be a first downlink control information (DCI) in a physical downlink control channel (PDCCH) and the second downlink control channel may use the same DCI in PDCCH, an additional DCI in PDCCH, a MAC CE, or a CSI embedded in a physical downlink shared channel (PDSCH).

In this first alternative in which the second proposal discussed above is adopted in which the 8Tx precoding matrices are used based on Equation (6) below:

$${W}_{l , m , n}^{r} = \frac{1}{\sqrt{2}} [ \begin{matrix}{[ {H}_{4 , l} ]}^{( r )} \\ {[ {H}_{4 , m} ]}^{( r )} [ \begin{matrix}{φ}_{{n}_{0}} & … & 0 \\ & ⋱ & \\ 0 & … & {φ}_{{n}_{r - 1}}\end{matrix} ]\end{matrix} ] ,$$

in which

$$[ \begin{matrix}{φ}_{{n}_{0}} & … & 0 \\ & ⋱ & \\ 0 & … & {φ}_{{n}_{r - 1}}\end{matrix} ] , {φ}_{{n}_{i}} = {e}^{j 2 π {n}_{i} / N} , {n}_{i} ∈ \{ 0 , ... N - 1 \} , i = 0 , ... , r - 1.$$

This may again result in various control information being indicated for PUSCH transmission (for example the uplink transmission) in control signaling 220. For example, wideband information may be indicated in a first downlink control channel. The wideband information may include the RI (for example using two bits), an upper precoding matrix (PMI_{U}) l: using 4 bits indicating 16 or 12 states, and a lower precoding matrix PMI_{L}) m: using 4 bits indicating 16 or 12 states. The wideband or subband information may be indicated by a second downlink control channel, such as the co-phasing index n: using 2 bits (for example for QPSK) or 3 bits (for example for 8PSK) for each layer and for each wide/subband. The first downlink control channel may be a first DCI in PDCCH, and the second downlink control channel may use the same DCI in PDCCH (for example the first DCI), an additional DCI in PDCCH (for example a second DCI), a MAC CE, or a CSI embedded in PDSCH.

In some examples of this first alternative, a PC codebook may be configured. The following 8Tx precoding matrices may be used

$${W}_{l}^{r} = \frac{1}{\sqrt{2}} [ \begin{matrix}{[ {H}_{4 , l} ]}^{( r )} \\ 0\end{matrix} ]$$

in examples in which a first antenna group/subset is used or

$$\frac{1}{\sqrt{2}} [ \begin{matrix}0 \\ {[ {H}_{4 , l} ]}^{( r )}\end{matrix} ]$$

in examples in which a second antenna group/subset are used. Wideband information may be indicated by DCI in PDCCH that is separately coded or jointly coded. The wideband information may include the RI (for example using two bits indicating four states), an antenna group selection indicator (for example using one bit to indicate two states/groups), and a precoding matrix (PMI) l: using 4 bits indicating 16 or 12 states.

In a second alternative, one codebook CSR configuration may be used. The CSR may be a CSR associated with NC subset(s), a CSR associated with NC+PC subset(s), or a CSR associated with NC+FC+PC subset(s). For example, the UE 205 or the base station 210 may identify or otherwise determine a single codebook for the uplink transmission that includes a first CSR for NC subset(s), for PC subset(s), or for FC subset(s) of the eight transmit antennas.

For example, an 8TX FC codebook may have precoding matrices formulated as

$${W}_{l , m , n}^{r} = \frac{1}{\sqrt{2}} [ \begin{matrix}{[ {H}_{4 , l} ]}^{( r )} \\ {{φ}_{n} [ {H}_{4 , m} ]}^{( r )}\end{matrix} ]$$

for the first proposal discussed above, or as

$${W}_{l , m , n}^{r} = \frac{1}{\sqrt{2}} [ \begin{matrix}{[ {H}_{4 , l} ]}^{( r )} \\ {[ {H}_{4 , m} ]}^{( r )} [ \begin{matrix}{φ}_{{n}_{0}} & … & 0 \\ & ⋱ & \\ 0 & … & {φ}_{{n}_{r - 1}}\end{matrix} ]\end{matrix} ] .$$

The 8Tx PC codebook may have precoding matrices formulated as

$${W}_{l}^{r} = \frac{1}{\sqrt{2}} [ \begin{matrix}{[ {H}_{4 , l} ]}^{( r )} \\ 0\end{matrix} ] or \frac{1}{\sqrt{2}} [ \begin{matrix}0 \\ {[ {H}_{4 , l} ]}^{( r )}\end{matrix} ] .$$

Assuming that the NC 8Tx codebook has X precoding matrices, the precoding matrices may be selected from:

$$[ \begin{matrix}1 \\ 0 \\ 0 \\ ⋮ \\ 0\end{matrix} ] , [ \begin{matrix}0 \\ 1 \\ 0 \\ ⋮ \\ 0\end{matrix} ] ... , [ \begin{matrix}0 \\ 0 \\ 0 \\ ⋮ \\ 1\end{matrix} ]$$

for a rank-1 port-selection with 8 matrices, from

$$[ \begin{matrix}1 & 0 \\ 0 & 1 \\ 0 & 0 \\ ⋮ & ⋮ \\ 0 & 0\end{matrix} ] , [ \begin{matrix}1 & 0 \\ 0 & 0 \\ 0 & 1 \\ ⋮ & ⋮ \\ 0 & 0\end{matrix} ] ... , [ \begin{matrix}0 & 0 \\ 0 & 0 \\ ⋮ & ⋮ \\ 1 & 0 \\ 0 & 1\end{matrix} ]$$

for a rank-2 port-selection with

$$( \begin{matrix}8 \\ 2\end{matrix} )$$

matrices, from

$$[ \begin{matrix}1 & 0 & 0 \\ 0 & 1 & 0 \\ 0 & 0 & 1 \\ ⋮ & ⋮ & ⋮ \\ 0 & 0 & 0\end{matrix} ] , ... , [ \begin{matrix}1 & 0 & 0 \\ ⋮ & ⋮ & ⋮ \\ 1 & 0 & 0 \\ 0 & 1 & 0 \\ 0 & 0 & 1\end{matrix} ]$$

for a rank-3 port-selection with

$$( \begin{matrix}8 \\ 3\end{matrix} )$$

matrices, and from

$$[ \begin{matrix}1 & 0 & 0 & 0 \\ 0 & 1 & 0 & 0 \\ 0 & 0 & 1 & 0 \\ 0 & 0 & 0 & 1 \\ ⋮ & ⋮ & ⋮ & ⋮ \\ 0 & 0 & 0 & 0\end{matrix} ] , ... , [ \begin{matrix}0 & 0 & 0 & 0 \\ ⋮ & ⋮ & ⋮ & ⋮ \\ 1 & 0 & 0 & 0 \\ 0 & 1 & 0 & 0 \\ 0 & 0 & 1 & 0 \\ 0 & 0 & 0 & 1\end{matrix} ]$$

for a rank-4 port-selection with

$$( \begin{matrix}8 \\ 4\end{matrix} )$$

matrices.

In this second alternative of the control signaling 220 for the NC, PC, FC codebooks, in examples in which the CSR=FC+PC+NC is configured the TPMI field (for example the PMI) may include 4×2×12 or 4×2×16 states to indicate one of the PC precoders illustrated above. The other states indicated in the control signaling 220 may be used to indicate the NC precoders. In examples in which the CSR=FC+PC+NC is configured, the TPMI field may include a 4×16×16 or a 4×12×12 states to indicate one of the FC precoders illustrated above in which the co-phasing index may be transmitted in another control channel. Or, the TPMI field may include a 4×2×12 or 4×2×16 states to indicate one of the PC precoders illustrated above, in which the other states may be used to indicate the NC precoders.

One non-limiting example of a TPMI designed according to these techniques is illustrated in Table 7 below. The example design illustrated in Table 7 below may be based on particular considerations. One consideration may include an NC codebook having 4 precoders for rank-1, 6 precoders for rank-2, 1 precoder for rank-3, and 1 precoder for rank-4. Another consideration may include there may be no additional PC precoders than the ones based on 12 4×4 Householder matrices (for example as discussed above). Another consideration may include the FC codebook being constructed based on 12 4×4 Householder matrices for precoding (for example as discussed in proposal 2 above).

TABLE 7

| TPMI Bit | | TPMI Bit | |
|---|---|---|---|
| field | | field | |
| mapped | codebookSubset = | mapped to | codebookSubset = |
| to index | FC + PC + NC | index | PC + NC |
| 0-107 | The same as PC + NC case | 0-11 | The same as NC case |
| 108 | 1 layer: FC TPMI = 0 | 12 | 1 layer: PC TPMI = 0 |
| 251 | 1 layer: FC TPMI = 143 | 35 | 1 layer: PC TPMI = 23 |
| 252 | 2 layers: FC TPMI = 0 | 36 | 2 layers: PC TPMI = 0 |
| . . . | . . . | . . . | . . . |
| 395 | 2 layers: FC TPMI = 143 | 59 | 2 layers: PC TPMI = 23 |
| 396 | 3 layers: FC TPMI = 0 | 60 | 3 layers: PC TPMI = 0 |
| . . . | . . . | . . . | . . . |
| 539 | 3 layers: FC TPMI = 143 | 83 | 3 layers: PC TPMI = 23 |
| 540 | 4 layers: FC TPMI = 0 | 84 | 4 layers: PC TPMI = 0 |
| . . . | . . . | . . . | . . . |
| 683 | 4 layers: FC TPMI = 143 | 107 | 4 layers: PC TPMI = 23 |

| TPMI Bit field | |
|---|---|
| mapped to index | codebookSubset = NC |
| 0 | 1 layer: NC TPMI = 0 |
| 3 | 1 layer: NC TPMI = 3 |
| 4 | 2 layers: NC TPMI = 0 |
| 9 | 2 layers: NC TPMI = 5 |
| 10 | 3 layers: NC TPMI = 0 |
| 11 | 4 layers: NC TPMI = 0 |

The base station 210 select the PMI/RI for the uplink transmissions performed by the UE 205. The PMI/RI may be selected, identified, or otherwise determined based on the reference signal(s) 215 received from the UE 205 (for example based, at least to some degree, on the channel performance characteristics of the channel between the UE 205 and the base station 210). The base station 210 may transmit or otherwise provide control signaling 220 (for example DCI(s) carried over PDCCH) to the UE 205 indicating the PMI/RI. The UE 205 may transmit or otherwise provide the uplink transmission(s) to the base station 210 that are configured based on the indicated PMI/RI. That is, the UE 205 may map data to physical resources based on the codebook constructed according to the techniques discussed herein.

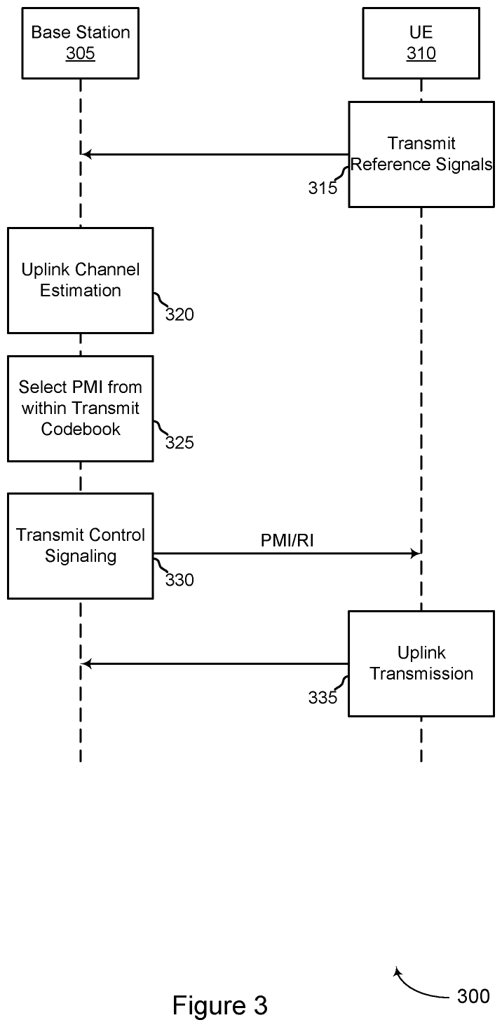

FIG. 3 illustrates an example of a process 300 that supports uplink codebook-based precoding by a UE having an advanced configuration of transmit antennas in accordance with aspects of the present disclosure. Process 300 may implement aspects of the wireless communications systems 100 or 200. Aspects of process 300 may be implemented at or implemented by the base station 305 or the UE 310, which may be examples of the corresponding devices described herein.

At 315, the UE 310 may transmit or otherwise provide (and the base station 305 may receive or otherwise obtain) reference signal(s) over a channel between the UE 310 and the base station 305. Broadly, the reference signal(s) may include any signal transmitted from the UE 310, such as channel state information reference signal (CSI-RS), sounding reference signal (SRS), demodulation reference signal (DMRS), physical uplink control channel (PUCCH), physical uplink shared channel (PUSCH). In some aspects, the UE 310 may transmit reference signals based at least in part on the UE 310 having at least eight (or more) transmit antennas, for example using beamformed or directional transmissions configured to cover various antenna configurations selected to ensure that the UE 310 uses at least each antenna from the eight transmit antennas, and at least each antenna from subset(s) of the eight transmit antennas.

At 320, the base station 305 may perform uplink channel estimation. For example, the base station 305 may monitor, measure, quantify, or otherwise determine various channel performance characteristics for the channel. For example, the base station 305 may measure, identify, or otherwise determine a reference signal received power (RSRP) value, a reference signal strength indicator (RSSI) value, a channel quality indicator (CQI), an error rate, and a throughput rate, for the channel.

At 325, the base station 305 may identify, select, or otherwise determine the PMI from within the transmit codebook. That is, the base station 305 may use the Householder matrix (for example 8×8), stacked Householder matrices (for example 4×4) that are selected based on the channel performance characteristics. For example, the base station 305 may implement or otherwise adopt the Householder matrix techniques discussed herein to select the uplink codebook to be used for the uplink transmissions from the UE 310, in which the uplink codebook improves uplink transmissions based on the UE 310 having the eight (or more) transmit antennas as well as the co-phasing relationship (for example phase differences) between different subsets of the eight (or more) antennas.

At 330, the base station 305 may transmit or otherwise provide (and the UE 310 may receive or otherwise obtain) control signaling identifying or otherwise indicating, explicitly or implicitly, the PMI/RI for the UE 310 to use for the uplink transmissions. Again, the PMI/RI indicated by the base station 305 may be selected based on the uplink codebook designs discussed herein.

At 335, the UE 310 may transmit or otherwise provide (and the base station 305 may receive or otherwise obtain) the uplink transmissions according to the indicated PMI/RI. For example, the UE 310 may map data bits to physical resources based on the indicated PMI/RI for transmission to the base station 305.

In some aspects, the base station 305 or the UE 310 may repeat the techniques discussed herein to update the PMI/RI for uplink transmissions from the UE 310.

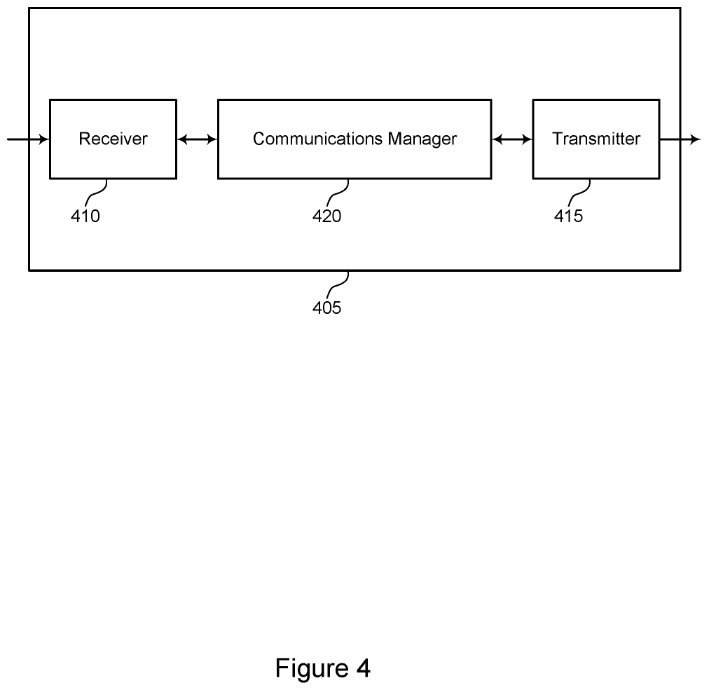

FIG. 4 shows a block diagram of a device 405 that supports uplink codebook-based precoding by a UE having an advanced configuration of transmit antennas in accordance with aspects of the present disclosure. The device 405 may be an example of aspects of a UE 115. The device 405 may include a receiver 410, a transmitter 415, and a communications manager 420. The communications manager 420 may be implemented, at least in part, by one or both of a modem and a processor. Each of these components may be in communication with one another (for example via buses).

The receiver 410 may provide a means for receiving information such as packets, user data, control information, or any combination thereof associated with various information channels (for example control channels, data channels, information channels related to uplink codebook and signaling design). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (for example control channels, data channels, information channels related to uplink codebook and signaling design). In some examples, the transmitter 415 may be co-located with a receiver 410 in a transceiver component. The transmitter 415 may utilize a single antenna or a set of multiple antennas.

The communications manager 420, the receiver 410, the transmitter 415, or various combinations thereof or various components thereof may be examples of means for performing various aspects of uplink codebook and signaling design. For example, the communications manager 420, the receiver 410, the transmitter 415, or various combinations or components thereof may support a method for performing the functions described herein.

In some examples, the communications manager 420, the receiver 410, the transmitter 415, or various combinations or components thereof may be implemented in hardware (for example in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform the functions described herein (for example by executing, by the processor, instructions stored in the memory).

Additionally or alternatively, the communications manager 420, the receiver 410, the transmitter 415, or various combinations or components thereof may be implemented in code (for example as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (for example configured as or otherwise supporting a means for performing the functions described in the present disclosure).

In some examples, the communications manager 420 may be configured to perform various operations (for example receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations.

The communications manager 420 may support wireless communication at a UE in accordance with examples as disclosed herein. For example, the communications manager 420 may be configured as or otherwise support a means for transmitting, to a base station, reference signal(s) over a channel. The communications manager 420 may be configured as or otherwise support a means for receiving, from the base station based on transmitting the reference signal(s), control signaling indicating a PMI and a RI, the precoding matrix and the RI being based on the UE having at least eight transmit antennas and based on a phase difference between different subsets of transmit antennas of the at least eight transmit antennas. The communications manager 420 may be configured as or otherwise support a means for transmitting, to the base station, an uplink transmission configured according to the PMI and the RI.

By including or configuring the communications manager 420 in accordance with examples, the device 405 (for example a processor controlling or otherwise coupled to the receiver 410, the transmitter 415, the communications manager 420, or a combination thereof) may support techniques for improved uplink codebook design that improves mapping/utilization of the eight (or more) transmit antennas of the UE given the co-polarization (for example phase difference) between different subsets of the UE's antennas.

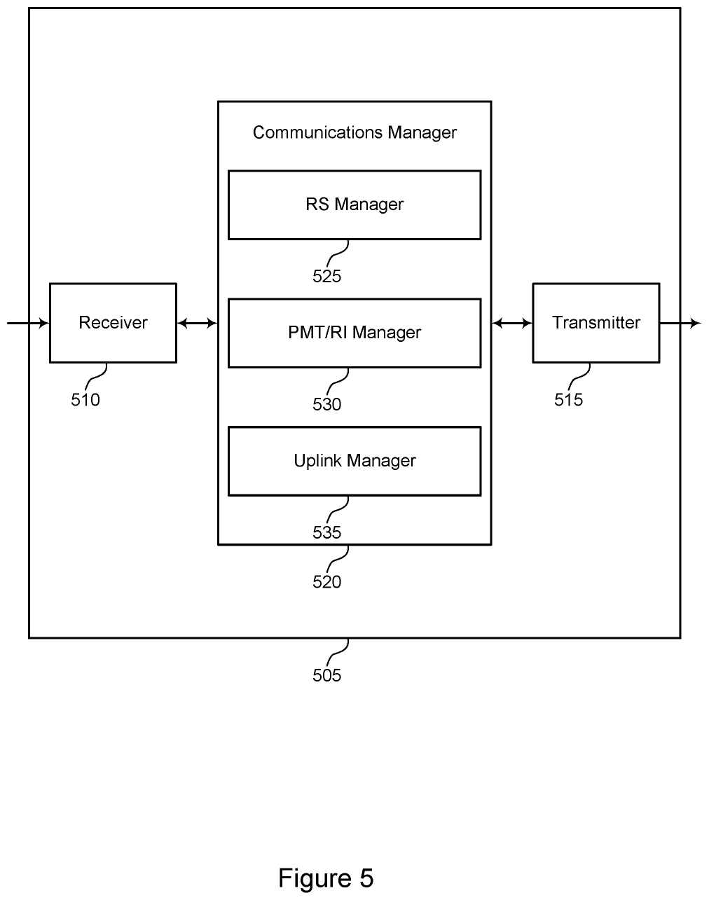

FIG. 5 shows a block diagram of a device 505 that supports uplink codebook-based precoding by a UE having an advanced configuration of transmit antennas in accordance with aspects of the present disclosure. The device 505 may be an example of aspects of a device 405 or a UE 115. The device 505 may include a receiver 510, a transmitter 515, and a communications manager 520. The communications manager 520 may be implemented, at least in part, by one or both of a modem and a processor. Each of these components may be in communication with one another (for example via buses).

The receiver 510 may provide a means for receiving information such as packets, user data, control information, or any combination thereof associated with various information channels (for example control channels, data channels, information channels related to uplink codebook and signaling design). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (for example control channels, data channels, information channels related to uplink codebook and signaling design). In some examples, the transmitter 515 may be co-located with a receiver 510 in a transceiver component. The transmitter 515 may utilize a single antenna or a set of multiple antennas.

The device 505, or various components thereof, may be an example of means for performing various aspects of uplink codebook and signaling design. For example, the communications manager 520 may include a reference signal (RS) manager 525, an PMT/RI manager 530, an uplink manager 535, or any combination thereof. The communications manager 520 may be an example of aspects of a communications manager 420. In some examples, the communications manager 520, or various components thereof, may be configured to perform various operations (for example receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations.

The communications manager 520 may support wireless communication at a UE in accordance with examples as disclosed herein. The RS manager 525 may be configured as or otherwise support a means for transmitting, to a base station, reference signal(s) over a channel. The PMT/RI manager 530 may be configured as or otherwise support a means for receiving, from the base station based on transmitting the reference signal(s), control signaling indicating a PMI and a RI, the PMI and the RI being based on the UE having at least eight transmit antennas and based on a phase difference between different subsets transmit antennas of the at least eight transmit antennas. The uplink manager 535 may be configured as or otherwise support a means for transmitting, to the base station, an uplink transmission configured according to the PMI and the RI.

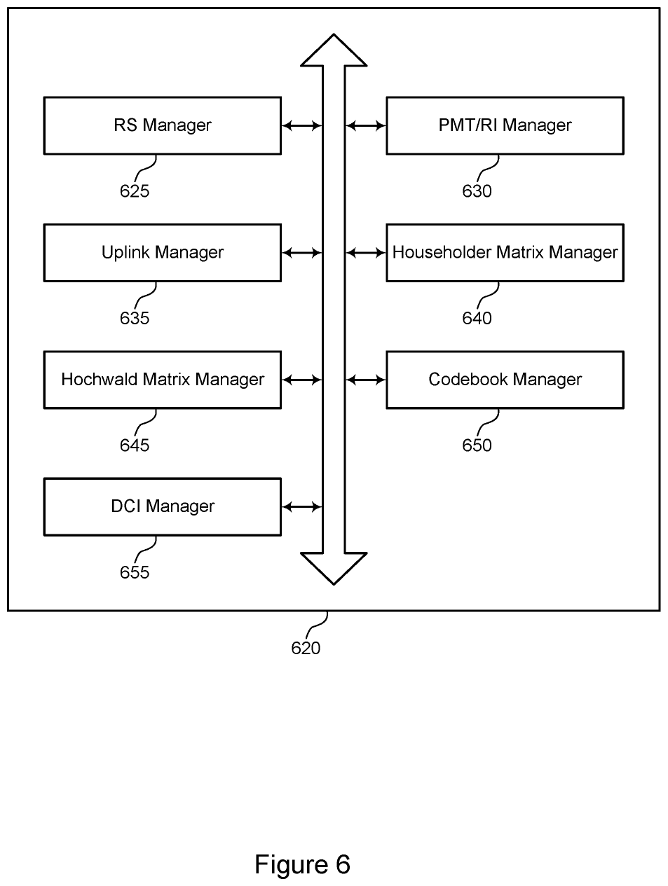

FIG. 6 shows a block diagram of a communications manager 620 that supports uplink codebook-based precoding by a UE having an advanced configuration of transmit antennas in accordance with aspects of the present disclosure. The communications manager 620, or various components thereof, may be an example of means for performing various aspects of uplink codebook and signaling design. For example, the communications manager 620 may include an RS manager 625, an PMT/RI manager 630, an uplink manager 635, a householder matrix manager 640, a Hochwald matrix manager 645, a codebook manager 650, a DCI manager 655, or any combination thereof. Each of these components may communicate, directly or indirectly, with one another (for example via buses).

The communications manager 620 may support wireless communication at a UE in accordance with examples as disclosed herein. The RS manager 625 may be configured as or otherwise support a means for transmitting, to a base station, reference signal(s) over a channel. The PMT/RI manager 630 may be configured as or otherwise support a means for receiving, from the base station based on transmitting the reference signal(s), control signaling indicating a PMI and a RI, the PMI being based on the UE having at least eight transmit antennas and based on a phase difference between different subsets of transmit antennas of the at least eight transmit antennas. The uplink manager 635 may be configured as or otherwise support a means for transmitting, to the base station, an uplink transmission configured according to the PMI and the RI.

In some examples, the householder matrix manager 640 may be configured as or otherwise support a means for determining, based on the at least eight transmit antennas, a householder matrix that is at least eight-by-eight for the uplink transmission, the PMI and the RI being based on the householder matrix.

In some examples, the householder matrix manager 640 may be configured as or otherwise support a means for determining a co-phasing parameter for each of a plurality of different subsets of transmit antennas of the at least eight transmit antennas. In some examples, the householder matrix manager 640 may be configured as or otherwise support a means for determining a first householder matrix for a first subset of the at least eight transmit antennas and a second householder matrix for a second subset of the at least eight transmit antennas, in which the PMI, the RI, or both, are based on the first householder matrix and the second householder matrix and based on the co-phasing parameter of the first subset and the second subset.

In some examples, the householder matrix manager 640 may be configured as or otherwise support a means for determining per-layer co-phasing parameter(s) for each of a plurality of different subsets of transmit antennas of the at least eight transmit antennas. In some examples, the householder matrix manager 640 may be configured as or otherwise support a means for determining a first householder matrix for a first subset of the at least eight transmit antennas and a second householder matrix for a second subset of the at least eight transmit antennas, in which the PMI, the RI, or both, are based on the first householder matrix and the second householder matrix and based on the per-layer co-phasing parameter of the first subset and the second subset.

In some examples, the codebook manager 650 may be configured as or otherwise support a means for determining a first codebook for the uplink transmission that includes a first codebook subset restriction associated with non-coherent subsets of transmit antennas of the at least eight transmit antennas. In some examples, the codebook manager 650 may be configured as or otherwise support a means for determining a second codebook for the uplink transmission that includes a second codebook subset restriction associated with partially coherent subsets of the transmit antennas of the at least eight transmit antennas. In some examples, the codebook manager 650 may be configured as or otherwise support a means for determining a third codebook for the uplink transmission that includes a third codebook subset restriction associated with fully coherent subsets of transmit antennas of the at least eight transmit antennas.

In some examples, the codebook manager 650 may be configured as or otherwise support a means for determining a single codebook for the uplink transmission that includes a first codebook subset restriction associated with non-coherent subsets of transmit antennas, partially coherent subsets of transmit antennas, fully coherent subsets of transmit antennas, or any combination thereof, of the at least eight transmit antennas.

In some examples, to support receiving the control signaling, the DCI manager 655 may be configured as or otherwise support a means for receiving, in a first physical downlink control channel, a first downlink control information message indicating the RI, an upper PMI and a lower PMI for the uplink transmission, in which the PMI is based on the upper PMI and the lower PMI. In some examples, to support receiving the control signaling, the DCI manager 655 may be configured as or otherwise support a means for receiving, in a second physical downlink control channel, the first downlink control information message and an indication of a co-phasing index between different subsets of transmit antennas of the at least eight transmit antennas.

In some examples, the indication of the co-phasing index is received in the first downlink control information message, in a medium access control-control element, in a channel state information report, or any combination thereof.

In some examples, to support receiving the control signaling, the DCI manager 655 may be configured as or otherwise support a means for receiving, in a physical downlink control channel, a downlink control information message indicating the PMI, the RI, and an identifier of a subset of transmit antennas from the at least eight transmit antennas for the uplink transmission, where transmitting the uplink transmission is based on the subset of transmit antennas.

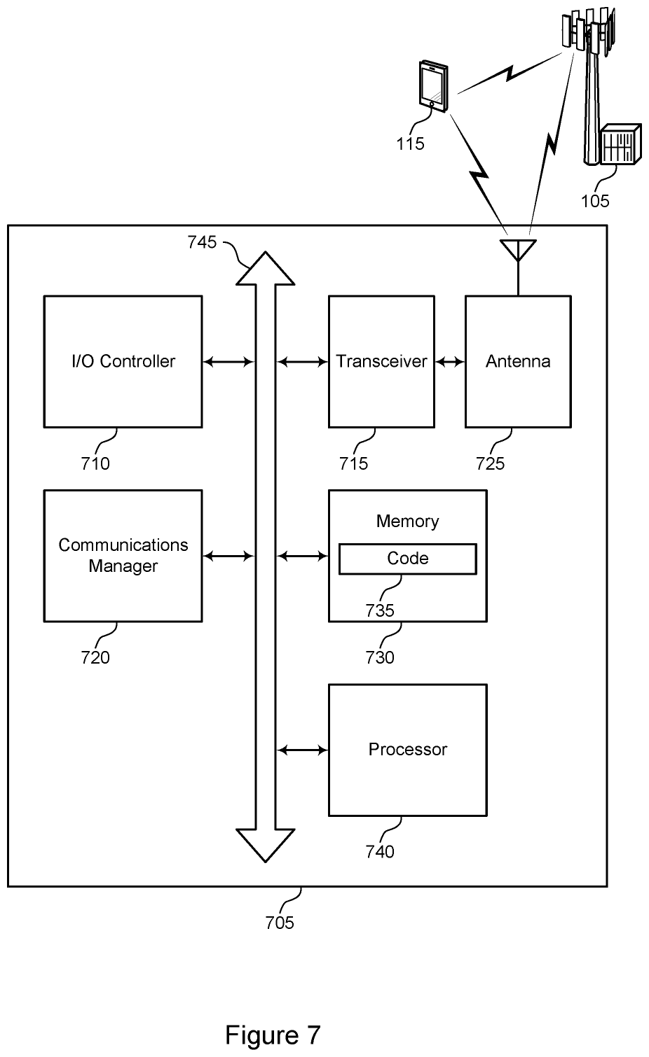

FIG. 7 shows a diagram of a system including a device 705 that supports uplink codebook-based precoding by a UE having an advanced configuration of transmit antennas in accordance with aspects of the present disclosure. The device 705 may be an example of or include the components of a device 405, a device 505, or a UE 115. The device 705 may communicate wirelessly with base station(s) 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (for example operatively, communicatively, functionally, electronically, electrically) via buses (for example a bus 745).

The I/O controller 710 may manage input and output signals for the device 705. The I/O controller 710 may also manage peripherals not integrated into the device 705. In some examples, the I/O controller 710 may represent a physical connection or port to an external peripheral. In some examples, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some examples, the I/O controller 710 may be implemented as part of a processor, such as the processor 740. In some examples, a user may interact with the device 705 via the I/O controller 710 or via hardware components controlled by the I/O controller 710.

In some examples, the device 705 may include a single antenna 725. However, the device 705 may have more than one antenna 725, which may be capable of concurrently transmitting or receiving multiple wireless transmissions. The transceiver 715 may communicate bi-directionally, via the antennas 725, wired, or wireless links. For example, the transceiver 715 may represent a wireless transceiver and may communicate bi-directionally with another wireless transceiver. The transceiver 715 may also include a modem to modulate the packets, to provide the modulated packets to antennas 725 for transmission, and to demodulate packets received from the antennas 725. The transceiver 715, or the transceiver 715 and antennas 725, may be an example of a transmitter 415, a transmitter 515, a receiver 410, a receiver 510, or any combination thereof or component thereof.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some examples, the code 735 may not be directly executable by the processor 740 but may cause a computer (for example when compiled and executed) to perform functions described herein. In some examples, the memory 730 may contain, among other things, a basic I/O system (BIOS) which may control basic hardware or software operation such as the interaction with peripheral components or devices.

The processor 740 may include an intelligent hardware device (for example a general-purpose processor, a DSP, a CPU, a microcontroller, an ASIC, an FPGA, a programmable logic device, a discrete gate or transistor logic component, a discrete hardware component, or any combination thereof). In some examples, the processor 740 may be configured to operate a memory array using a memory controller. In some other cases, a memory controller may be integrated into the processor 740. The processor 740 may be configured to execute computer-readable instructions stored in a memory (for example the memory 730) to cause the device 705 to perform various functions (for example functions or tasks supporting uplink codebook and signaling design). For example, the device 705 or a component of the device 705 may include a processor 740 and memory 730 coupled to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for transmitting, to a base station, reference signal(s) over a channel. The communications manager 720 may be configured as or otherwise support a means for receiving, from the base station based on transmitting the reference signal(s), control signaling indicating a PMI and a RI, the PMI and the RI being based on the UE having at least eight transmit antennas and based on a phase difference between different subsets of transmit antennas of the at least eight transmit antennas. The communications manager 720 may be configured as or otherwise support a means for transmitting, to the base station, an uplink transmission configured according to the PMI and the RI.

By including or configuring the communications manager 720 in accordance with examples, the device 705 may support techniques for improved uplink codebook design that improves mapping/utilization of the eight (or more) transmit antennas of the UE given the co-polarization (for example phase difference) between different subsets of the UE's antennas.

In some examples, the communications manager 720 may be configured to perform various operations (for example receiving, monitoring, transmitting) using or otherwise in cooperation with the transceiver 715, the antennas 725, or any combination thereof. Although the communications manager 720 is illustrated as a separate component, the functions described with reference to the communications manager 720 may be supported by or performed by the processor 740, the memory 730, the code 735, or any combination thereof. For example, the code 735 may include instructions executable by the processor 740 to cause the device 705 to perform various aspects of uplink codebook and signaling design, or the processor 740 and the memory 730 may be otherwise configured to perform or support such operations.

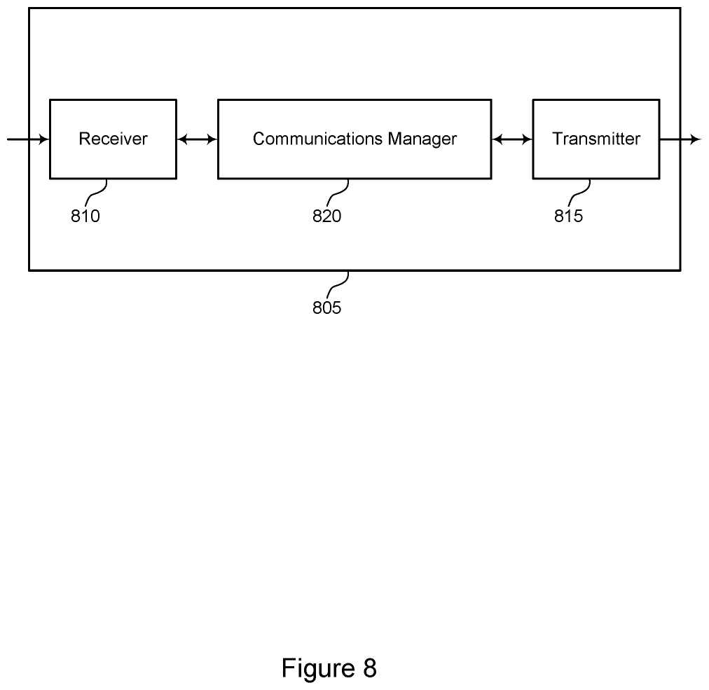

FIG. 8 shows a block diagram of a device 805 that supports uplink codebook-based precoding by a UE having an advanced configuration of transmit antennas in accordance with aspects of the present disclosure. The device 805 may be an example of aspects of a base station 105. The device 805 may include a receiver 810, a transmitter 815, and a communications manager 820. The communications manager 820 may be implemented, at lest in part, by one or both of a modem and a processor. Each of these components may be in communication with one another (for example via buses).

The receiver 810 may provide a means for receiving information such as packets, user data, control information, or any combination thereof associated with various information channels (for example control channels, data channels, information channels related to uplink codebook and signaling design). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (for example control channels, data channels, information channels related to uplink codebook and signaling design). In some examples, the transmitter 815 may be co-located with a receiver 810 in a transceiver component. The transmitter 815 may utilize a single antenna or a set of multiple antennas.

The communications manager 820, the receiver 810, the transmitter 815, or various combinations thereof or various components thereof may be examples of means for performing various aspects of uplink codebook and signaling design. For example, the communications manager 820, the receiver 810, the transmitter 815, or various combinations or components thereof may support a method for performing the functions described herein.

In some examples, the communications manager 820, the receiver 810, the transmitter 815, or various combinations or components thereof may be implemented in hardware (for example in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform the functions described herein (for example by executing, by the processor, instructions stored in the memory).

Additionally or alternatively, the communications manager 820, the receiver 810, the transmitter 815, or various combinations or components thereof may be implemented in code (for example as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (for example configured as or otherwise supporting a means for performing the functions described in the present disclosure).

In some examples, the communications manager 820 may be configured to perform various operations (for example receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations.

The communications manager 820 may support wireless communication at a base station in accordance with examples as disclosed herein. For example, the communications manager 820 may be configured as or otherwise support a means for selecting, based on reference signal(s) received from a UE, a PMI and a RI, the PMI and the RI being based on the UE having at least eight transmit antennas and based on a phase difference between different subsets of transmit antennas of the at least eight transmit antennas. The communications manager 820 may be configured as or otherwise support a means for transmitting, to the UE, control signaling indicating the PMI and the RI. The communications manager 820 may be configured as or otherwise support a means for receiving, from the UE, an uplink transmission configured based on the PMI and the RI.

By including or configuring the communications manager 820 in accordance with examples, the device 805 (for example a processor controlling or otherwise coupled to the receiver 810, the transmitter 815, the communications manager 820, or a combination thereof) may support techniques for improved uplink codebook design that improves mapping/utilization of the eight (or more) transmit antennas of the UE given the co-polarization (for example phase difference) between different subsets of the UE's antennas.

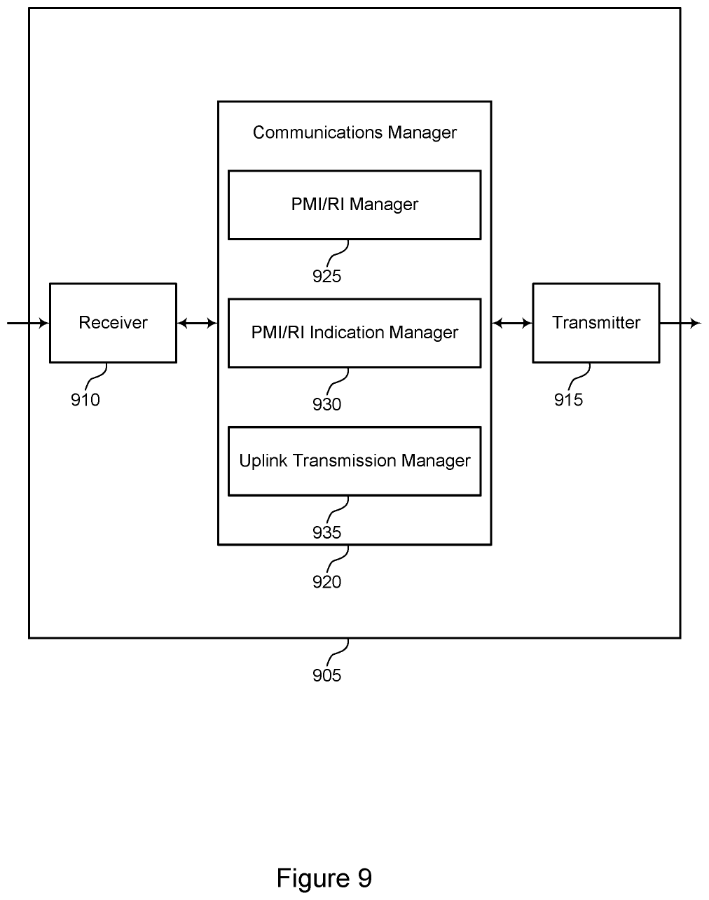

FIG. 9 shows a block diagram of a device 905 that supports uplink codebook-based precoding by a UE having an advanced configuration of transmit antennas in accordance with aspects of the present disclosure. The device 905 may be an example of aspects of a device 805 or a base station 105. The device 905 may include a receiver 910, a transmitter 915, and a communications manager 920. The communications manager 920 may be implemented, at lest in part, by one or both of a modem and a processor. Each of these components may be in communication with one another (for example via buses).

The receiver 910 may provide a means for receiving information such as packets, user data, control information, or any combination thereof associated with various information channels (for example control channels, data channels, information channels related to uplink codebook and signaling design). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (for example control channels, data channels, information channels related to uplink codebook and signaling design). In some examples, the transmitter 915 may be co-located with a receiver 910 in a transceiver component. The transmitter 915 may utilize a single antenna or a set of multiple antennas.

The device 905, or various components thereof, may be an example of means for performing various aspects of uplink codebook and signaling design. For example, the communications manager 920 may include a PMI/RI manager 925, a PMI/RI indication manager 930, an uplink transmission manager 935, or any combination thereof. In some examples, the communications manager 920, or various components thereof, may be configured to perform various operations (for example receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations.

The communications manager 920 may support wireless communication at a base station in accordance with examples as disclosed herein. The PMI/RI manager 925 may be configured as or otherwise support a means for selecting, based on reference signal(s) received from a UE, a PMI and a RI, the PMI and the RI being based on the UE having at least eight transmit antennas and based on a phase difference between different subsets of transmit antennas of the at least eight transmit antennas. The PMI/RI indication manager 930 may be configured as or otherwise support a means for transmitting, to the UE, control signaling indicating the PMI and the RI. The uplink transmission manager 935 may be configured as or otherwise support a means for receiving, from the UE, an uplink transmission configured based on the PMI and the RI.

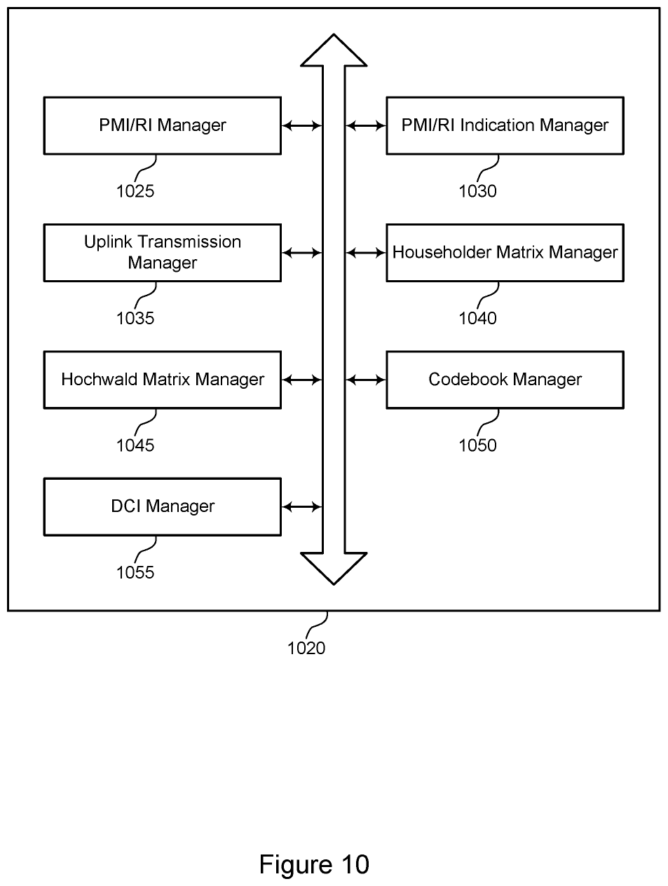

FIG. 10 shows a block diagram of a communications manager 1020 that supports uplink codebook and signaling design for multi-transmit antenna UE in accordance with aspects of the present disclosure. The communications manager 1020, or various components thereof, may be an example of means for performing various aspects of uplink codebook and signaling design. For example, the communications manager 1020 may include a PMI/RI manager 1025, a PMI/RI indication manager 1030, an uplink transmission manager 1035, a householder matrix manager 1040, a Hochwald matrix manager 1045, a codebook manager 1050, a DCI manager 1055, or any combination thereof. Each of these components may communicate, directly or indirectly, with one another (for example via buses).

The communications manager 1020 may support wireless communication at a base station in accordance with examples as disclosed herein. The PMI/RI manager 1025 may be configured as or otherwise support a means for selecting, based on reference signal(s) received from a UE, a PMI and a RI, the PMI and the RI being based on the UE having at least eight transmit antennas and based on a phase difference between different subsets of transmit antennas of the at least eight transmit antennas. The PMI/RI indication manager 1030 may be configured as or otherwise support a means for transmitting, to the UE, control signaling indicating the PMI and the RI. The uplink transmission manager 1035 may be configured as or otherwise support a means for receiving, from the UE, an uplink transmission configured based on the PMI and the RI.

In some examples, the householder matrix manager 1040 may be configured as or otherwise support a means for decoding, based on the at least eight transmit antennas, the uplink transmission based on a householder matrix that is at least eight-by-eight, in which the PMI and the RI being based on the householder matrix.

In some examples, the householder matrix manager 1040 may be configured as or otherwise support a means for determining a co-phasing parameter for each of a plurality of different subsets of transmit antennas of the at least eight transmit antennas. In some examples, the householder matrix manager 1040 may be configured as or otherwise support a means for decoding the uplink transmission based on a first householder matrix for a first subset of the at least eight transmit antennas and a second householder matrix for a second subset of the at least eight transmit antennas, in which the PMI, the RI, or both, are based on the first householder matrix and the second householder matrix and the first householder matrix and the second householder matrix are based on the co-phasing parameter of the first subset and the second subset.

In some examples, the householder matrix manager 1040 may be configured as or otherwise support a means for determining per-layer co-phasing parameter(s) for each of a plurality of different subsets of transmit antennas of the at least eight transmit antennas. In some examples, the householder matrix manager 1040 may be configured as or otherwise support a means for decoding the uplink transmission based on a first householder matrix for a first subset of the at least eight transmit antennas and a second householder matrix for a second subset of the at least eight transmit antennas, in which the PMI, the RI, or both, are based on the first householder matrix and the second householder matrix and the first householder matrix and the second householder matrix are based on the per-layer co-phasing parameter of the first subset and the second subset.

In some examples, the codebook manager 1050 may be configured as or otherwise support a means for decoding the uplink transmission based on a first codebook for the uplink transmission that includes a first codebook subset restriction associated with non-coherent subsets of transmit antennas of the at least eight transmit antennas, a second codebook for the uplink transmission that includes a second codebook subset restriction associated with partially coherent subsets of transmit antennas of the at least eight transmit antennas, or a third codebook for the uplink transmission that includes a third codebook subset restriction associated with fully coherent subsets of transmit antennas of the at least eight transmit antennas.

In some examples, the codebook manager 1050 may be configured as or otherwise support a means for decoding the uplink transmission based on a single codebook for the uplink transmission that includes a first codebook subset restriction associated with non-coherent subsets of transmit antennas, partially coherent subsets of transmit antennas, fully coherent subsets of transmit antennas, or any combination thereof, of the at least eight transmit antennas.

In some examples, to support transmitting the control signaling, the DCI manager 1055 may be configured as or otherwise support a means for transmitting, in a first physical downlink control channel, a first downlink control information message indicating the RI, an upper PMI and a lower PMI for the uplink transmission, in which the PMI is based on the upper PMI and the lower PMI. In some examples, to support transmitting the control signaling, the DCI manager 1055 may be configured as or otherwise support a means for transmitting, in a second physical downlink control channel, the first downlink control information message and an indication of a co-phasing index between different subsets of transmit antennas of the at least eight transmit antennas.

In some examples, the indication of the co-phasing index is transmitted in the first downlink control information message, in a medium access control-control element, in a channel state information report, or any combination thereof.

In some examples, to support transmitting the control signaling, the DCI manager 1055 may be configured as or otherwise support a means for transmitting, in a physical downlink control channel, a downlink control information message indicating the PMI, the RI, and an identifier of a subset of transmit antennas from the at least transmit antennas, for the uplink transmission, where receiving the uplink transmission is based on the subset of transmit antennas.

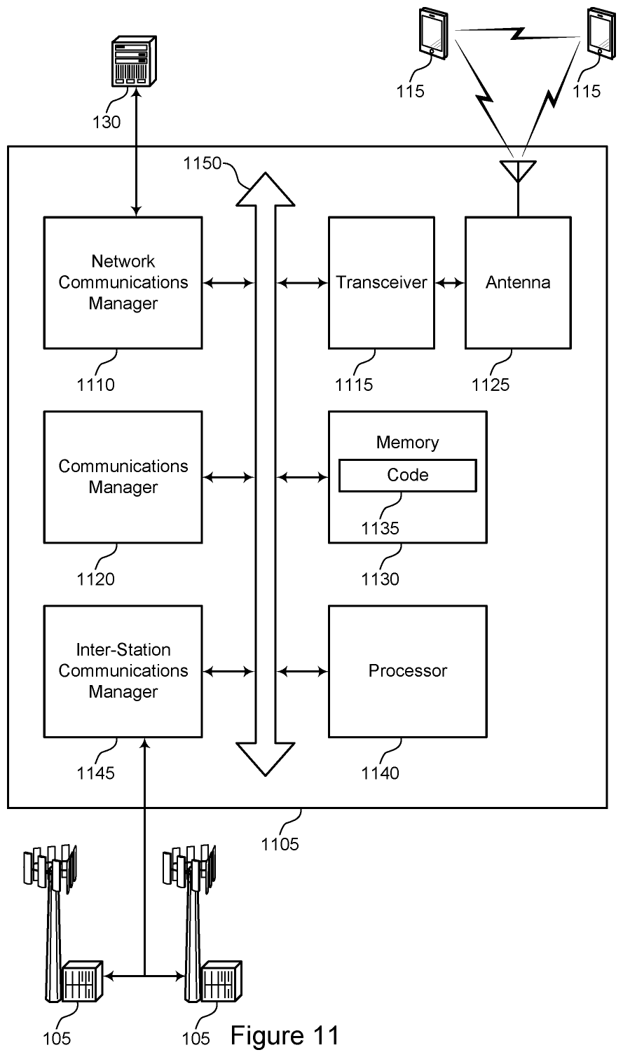

FIG. 11 shows a diagram of a system including a device 1105 that supports uplink codebook-based precoding by a UE having an advanced configuration of transmit antennas in accordance with aspects of the present disclosure. The device 1105 may be an example of or include the components of a device 805, a device 905, or a base station 105. The device 1105 may communicate wirelessly with base stations 105, UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (for example operatively, communicatively, functionally, electronically, electrically) via buses (for example a bus 1150).

The network communications manager 1110 may manage communications with a core network 130 (for example via wired backhaul links). For example, the network communications manager 1110 may manage the transfer of data communications for client devices, such as UEs 115.

In some examples, the device 1105 may include a single antenna 1125. However, the device 1105 may have more than one antenna 1125, which may be capable of concurrently transmitting or receiving multiple wireless transmissions. The transceiver 1115 may communicate bi-directionally, via the antennas 1125, wired, or wireless links. For example, the transceiver 1115 may represent a wireless transceiver and may communicate bi-directionally with another wireless transceiver. The transceiver 1115 may also include a modem to modulate the packets, to provide the modulated packets to antennas 1125 for transmission, and to demodulate packets received from the antennas 1125. The transceiver 1115, or the transceiver 1115 and antennas 1125, may be an example of a transmitter 815, a transmitter 915, a receiver 810, a receiver 910, or any combination thereof or component thereof.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some examples, the code 1135 may not be directly executable by the processor 1140 but may cause a computer (for example when compiled and executed) to perform functions described herein. In some examples, the memory 1130 may contain, among other things, a BIOS which may control basic hardware or software operation such as the interaction with peripheral components or devices.

The processor 1140 may include an intelligent hardware device (for example a general-purpose processor, a DSP, a CPU, a microcontroller, an ASIC, an FPGA, a programmable logic device, a discrete gate or transistor logic component, a discrete hardware component, or any combination thereof). In some examples, the processor 1140 may be configured to operate a memory array using a memory controller. In some other cases, a memory controller may be integrated into the processor 1140. The processor 1140 may be configured to execute computer-readable instructions stored in a memory (for example the memory 1130) to cause the device 1105 to perform various functions (for example functions or tasks supporting uplink codebook and signaling design). For example, the device 1105 or a component of the device 1105 may include a processor 1140 and memory 1130 coupled to the processor 1140, the processor 1140 and memory 1130 configured to perform various functions described herein.

The inter-station communications manager 1145 may manage communications with other base stations 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

The communications manager 1120 may support wireless communication at a base station in accordance with examples as disclosed herein. For example, the communications manager 1120 may be configured as or otherwise support a means for selecting, based on reference signal(s) received from a UE, a PMI and a RI, the PMI and the RI being based on the UE having at least eight transmit antennas and based on a phase difference between different subsets of transmit antennas of the at least eight transmit antennas. The communications manager 1120 may be configured as or otherwise support a means for transmitting, to the UE, control signaling indicating the PMI and the RI. The communications manager 1120 may be configured as or otherwise support a means for receiving, from the UE, an uplink transmission configured based on the PMI and the RI.

By including or configuring the communications manager 1120 in accordance with examples, the device 1105 may support techniques for improved uplink codebook design that improves mapping/utilization of the eight (or more) transmit antennas of the UE given the co-polarization (for example phase difference) between different subsets of the UE's antennas.

In some examples, the communications manager 1120 may be configured to perform various operations (for example receiving, monitoring, transmitting) using or otherwise in cooperation with the transceiver 1115, the antennas 1125, or any combination thereof. Although the communications manager 1120 is illustrated as a separate component, the functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of uplink codebook and signaling design, or the processor 1140 and the memory 1130 may be otherwise configured to perform or support such operations.

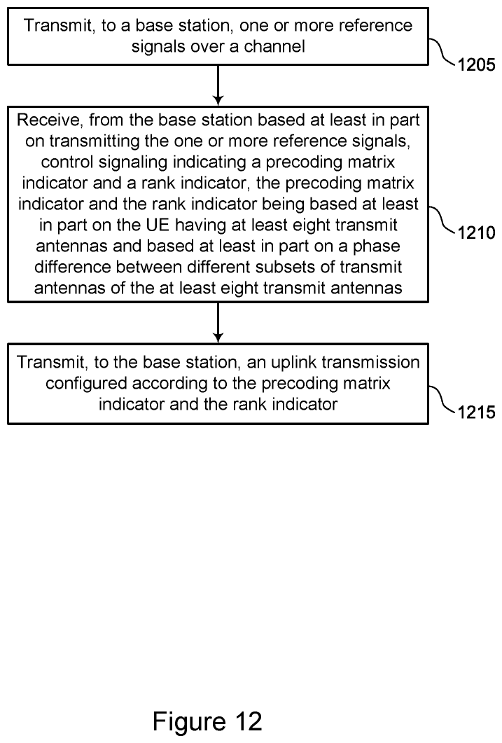

FIG. 12 shows a flowchart illustrating a method that supports uplink codebook-based precoding by a UE having an advanced configuration of transmit antennas in accordance with aspects of the present disclosure. The operations of the method may be implemented by a UE or its components. For example, the operations of the method may be performed by a UE 115 described with reference to FIGS. 1-7. In some examples, a UE may execute a set of instructions to control the functional elements of the UE to perform the described functions. Additionally or alternatively, the UE may perform aspects of the described functions using special-purpose hardware.

At 1205, the method may include transmitting, to a base station, reference signal(s) over a channel. The operations of 1205 may be performed in accordance with examples as disclosed herein. In some examples, aspects of the operations of 1205 may be performed by an RS manager 625 as described with reference to FIG. 6.

At 1210, the method may include receiving, from the base station based on transmitting the reference signal(s), control signaling indicating a PMI and a RI, the PMI and the RI being based on the UE having at least eight transmit antennas and based on a phase difference between different subsets of transmit antennas of the at least eight transmit antennas. The operations of 1210 may be performed in accordance with examples as disclosed herein. In some examples, aspects of the operations of 1210 may be performed by an PMT/RI manager 630 as described with reference to FIG. 6.

At 1215, the method may include transmitting, to the base station, an uplink transmission configured according to the PMI and the RI. The operations of 1215 may be performed in accordance with examples as disclosed herein. In some examples, aspects of the operations of 1215 may be performed by an uplink manager 635 as described with reference to FIG. 6.

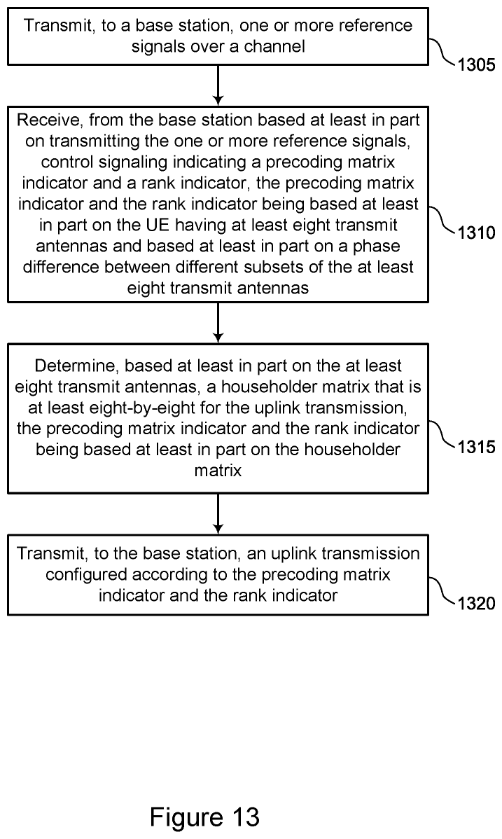

FIG. 13 shows a flowchart illustrating a method that supports uplink codebook-based precoding by a UE having an advanced configuration of transmit antennas in accordance with aspects of the present disclosure. The operations of the method may be implemented by a UE or its components as described herein. For example, the operations of the method may be performed by a UE 115 as described with reference to FIGS. 1-7. In some examples, a UE may execute a set of instructions to control the functional elements of the UE to perform the described functions. Additionally or alternatively, the UE may perform aspects of the described functions using special-purpose hardware.

At 1305, the method may include transmitting, to a base station, reference signal(s) over a channel. The operations of 1305 may be performed in accordance with examples as disclosed herein. In some examples, aspects of the operations of 1305 may be performed by an RS manager 625 as described with reference to FIG. 6.

At 1310, the method may include receiving, from the base station based on transmitting the reference signal(s), control signaling indicating a PMI and a RI, the PMI and the RI being based on the UE having at least eight transmit antennas and based on a phase difference between different subsets of transmit antennas of the at least eight transmit antennas. The operations of 1310 may be performed in accordance with examples as disclosed herein. In some examples, aspects of the operations of 1310 may be performed by an PMT/RI manager 630 as described with reference to FIG. 6.

At 1315, the method may include determining, based on the at least eight transmit antennas, a householder matrix that is at least eight-by-eight for the uplink transmission, the PMI and the RI being based on the householder matrix. The operations of 1315 may be performed in accordance with examples as disclosed herein. In some examples, aspects of the operations of 1315 may be performed by a householder matrix manager 640 as described with reference to FIG. 6.

At 1320, the method may include transmitting, to the base station, an uplink transmission configured according to the PMI and the RI. The operations of 1320 may be performed in accordance with examples as disclosed herein. In some examples, aspects of the operations of 1320 may be performed by an uplink manager 635 as described with reference to FIG. 6.

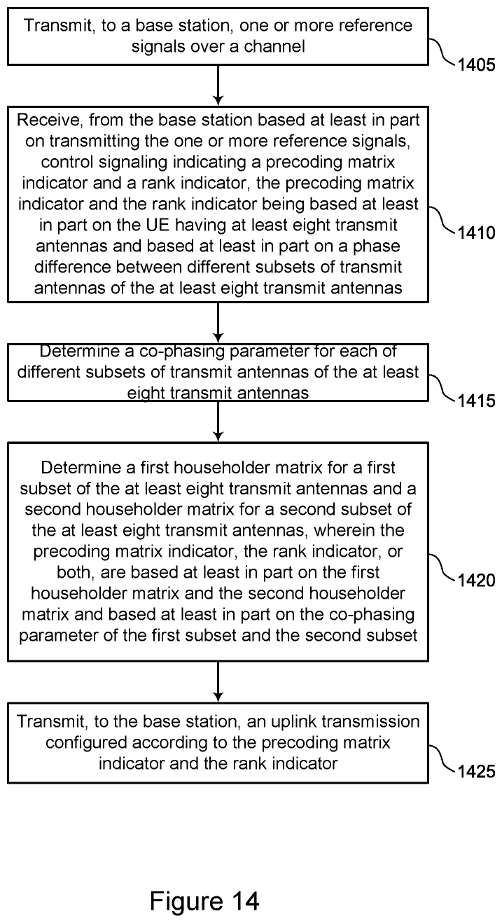

FIG. 14 shows a flowchart illustrating a method that supports uplink codebook-based precoding by a UE having an advanced configuration of transmit antennas in accordance with aspects of the present disclosure. The operations of the method may be implemented by a UE or its components as described herein. For example, the operations of the method may be performed by a UE 115 as described with reference to FIGS. 1-7. In some examples, a UE may execute a set of instructions to control the functional elements of the UE to perform the described functions. Additionally or alternatively, the UE may perform aspects of the described functions using special-purpose hardware.

At 1405, the method may include transmitting, to a base station, reference signal(s) over a channel. The operations of 1405 may be performed in accordance with examples as disclosed herein. In some examples, aspects of the operations of 1405 may be performed by an RS manager 625 as described with reference to FIG. 6.

At 1410, the method may include receiving, from the base station based on transmitting the reference signal(s), control signaling indicating a PMI and a RI, the PMI and the RI being based on the UE having at least eight transmit antennas and based on a phase difference between different subsets of transmit antennas of the at least eight transmit antennas. The operations of 1410 may be performed in accordance with examples as disclosed herein. In some examples, aspects of the operations of 1410 may be performed by an PMT/RI manager 630 as described with reference to FIG. 6.

At 1415, the method may include determining a co-phasing parameter for each of different subsets of transmit antennas of the at least eight transmit antennas. The operations of 1415 may be performed in accordance with examples as disclosed herein. In some examples, aspects of the operations of 1415 may be performed by a householder matrix manager 640 as described with reference to FIG. 6.

At 1420, the method may include determining a first householder matrix for a first subset of the at least eight transmit antennas and a second householder matrix for a second subset of the at least eight transmit antennas, in which the PMI, the RI, or both, are based on the first householder matrix and the second householder matrix and based on the co-phasing parameter of the first subset and the second subset. The operations of 1420 may be performed in accordance with examples as disclosed herein. In some examples, aspects of the operations of 1420 may be performed by a householder matrix manager 640 as described with reference to FIG. 6.

At 1425, the method may include transmitting, to the base station, an uplink transmission configured according to the PMI and the RI. The operations of 1425 may be performed in accordance with examples as disclosed herein. In some examples, aspects of the operations of 1425 may be performed by an uplink manager 635 as described with reference to FIG. 6.

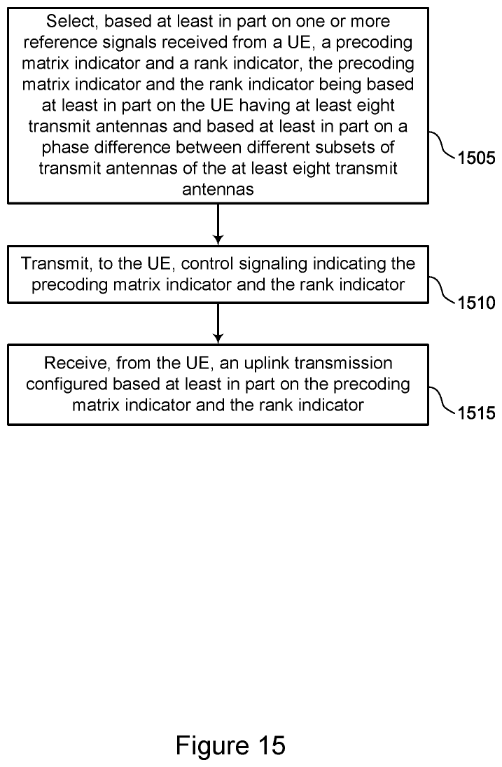

FIG. 15 shows a flowchart illustrating a method that supports uplink codebook-based precoding by a UE having an advanced configuration of transmit antennas in accordance with aspects of the present disclosure. The operations of the method may be implemented by a base station or its components as described herein. For example, the operations of the method may be performed by a base station 105 as described with reference to FIGS. 1-3 and 8-11. In some examples, a base station may execute a set of instructions to control the functional elements of the base station to perform the described functions. Additionally or alternatively, the base station may perform aspects of the described functions using special-purpose hardware.

At 1505, the method may include selecting, based on reference signal(s) received from a UE, a PMI and a RI, the PMI and the RI being based on the UE having at least eight transmit antennas and based on a phase difference between different subsets of transmit antennas of the at least eight transmit antennas. The operations of 1505 may be performed in accordance with examples as disclosed herein. In some examples, aspects of the operations of 1505 may be performed by a PMI/RI manager 1025 as described with reference to FIG. 10.

At 1510, the method may include transmitting, to the UE, control signaling indicating the PMI and the RI. The operations of 1510 may be performed in accordance with examples as disclosed herein. In some examples, aspects of the operations of 1510 may be performed by a PMI/RI indication manager 1030 as described with reference to FIG. 10.

At 1515, the method may include receiving, from the UE, an uplink transmission configured based on the PMI and the RI. The operations of 1515 may be performed in accordance with examples as disclosed herein. In some examples, aspects of the operations of 1515 may be performed by an uplink transmission manager 1035 as described with reference to FIG. 10.

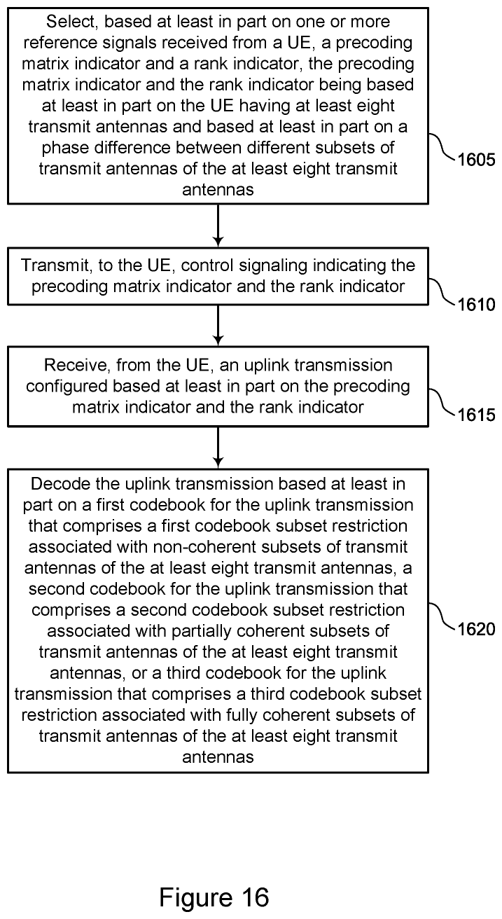

FIG. 16 shows a flowchart illustrating a method that supports uplink codebook-based precoding by a UE having an advanced configuration of transmit antennas in accordance with aspects of the present disclosure. The operations of the method may be implemented by a base station or its components as described herein. For example, the operations of the method may be performed by a base station 105 as described with reference to FIGS. 1-3 and 8-11. In some examples, a base station may execute a set of instructions to control the functional elements of the base station to perform the described functions. Additionally or alternatively, the base station may perform aspects of the described functions using special-purpose hardware.

At 1605, the method may include selecting, based on reference signal(s) received from a UE, a PMI and a RI, the PMI and the RI being based on the UE having at least eight transmit antennas and based on a phase difference between different subsets of transmit antennas of the at least eight transmit antennas. The operations of 1605 may be performed in accordance with examples as disclosed herein. In some examples, aspects of the operations of 1605 may be performed by a PMI/RI manager 1025 as described with reference to FIG. 10.

At 1610, the method may include transmitting, to the UE, control signaling indicating the PMI and the RI. The operations of 1610 may be performed in accordance with examples as disclosed herein. In some examples, aspects of the operations of 1610 may be performed by a PMI/RI indication manager 1030 as described with reference to FIG. 10.

At 1615, the method may include receiving, from the UE, an uplink transmission configured based on the PMI and the RI. The operations of 1615 may be performed in accordance with examples as disclosed herein. In some examples, aspects of the operations of 1615 may be performed by an uplink transmission manager 1035 as described with reference to FIG. 10.

At 1620, the method may include decoding the uplink transmission based on a first codebook for the uplink transmission that includes a first codebook subset restriction associated with non-coherent subsets of transmit antennas of the at least eight transmit antennas, a second codebook for the uplink transmission that includes a second codebook subset restriction associated with partially coherent subsets of transmit antennas of the at least eight transmit antennas, or a third codebook for the uplink transmission that includes a third codebook subset restriction associated with fully coherent subsets of transmit antennas of the at least eight transmit antennas. The operations of 1620 may be performed in accordance with examples as disclosed herein. In some examples, aspects of the operations of 1620 may be performed by a codebook manager 1050 as described with reference to FIG. 10.

The following provides an overview of aspects of the present disclosure:

Aspect 1: A method for wireless communication at a UE, comprising: transmitting, to a base station, one or more reference signals over a channel; receiving, from the base station based at least in part on transmitting the one or more reference signals, control signaling indicating a PMI and a RI, the PMI and the RI being based at least in part on the UE having at least eight transmit antennas and based at least in part on a phase difference between different subsets of transmit antennas of the at least eight transmit antennas; and transmitting, to the base station, an uplink transmission configured according to the PMI and the RI.

Aspect 2: The method of aspect 1, further comprising: determining, based at least in part on the at least eight transmit antennas, a householder matrix that is at least eight-by-eight for the uplink transmission, the PMI and the RI being based at least in part on the householder matrix.

Aspect 3: The method of any of aspects 1 through 2, further comprising: determining a co-phasing parameter for each of a plurality of different subsets of transmit antennas of the at least eight transmit antennas; and determining a first householder matrix for a first subset of the at least eight transmit antennas and a second householder matrix for a second subset of the at least eight transmit antennas, wherein the PMI, the RI, or both, are based at least in part on the first householder matrix and the second householder matrix and based at least in part on the co-phasing parameter of the first subset and the second subset.

Aspect 4: The method of any of aspects 1 through 3, further comprising: determining one or more per-layer co-phasing parameters for each of a plurality of different subsets of transmit antennas of the at least eight transmit antennas; and determining a first householder matrix for a first subset of the at least eight transmit antennas and a second householder matrix for a second subset of the at least eight transmit antennas, wherein the PMI, the RI, or both, are based at least in part on the first householder matrix and the second householder matrix and are based at least in part on the one or more per-layer co-phasing parameters of the first subset and the second subset.

Aspect 5: The method of any of aspects 1 through 4, further comprising: determining a first codebook for the uplink transmission that comprises a first codebook subset restriction associated with non-coherent subsets of transmit antennas of the at least eight transmit antennas; determining a second codebook for the uplink transmission that comprises a second codebook subset restriction associated with partially coherent subsets of transmit antennas of the at least eight transmit antennas; and determining a third codebook for the uplink transmission that comprises a third codebook subset restriction associated with fully coherent subsets of transmit antennas of the at least eight transmit antennas.

Aspect 6: The method of any of aspects 1 through 5, further comprising: determining a single codebook for the uplink transmission that comprises a first codebook subset restriction associated with at least one of non-coherent subsets of transmit antennas, partially coherent subsets of transmit antennas, or fully coherent subsets of transmit antennas, of the at least eight transmit antennas.

Aspect 7: The method of any of aspects 1 through 6, wherein receiving the control signaling comprises: receiving, in a first physical downlink control channel, a first downlink control information message indicating the RI, an upper PMI and a lower PMI for the uplink transmission, wherein the PMI is based at least in part on the upper PMI and the lower PMI; and receiving, in a second physical downlink control channel, the first downlink control information message and an indication of a co-phasing index between different subsets of transmit antennas of the at least eight transmit antennas.

Aspect 8: The method of aspect 7, wherein the indication of the co-phasing index is received in the first downlink control information message, in a medium access control-control element, or in a channel state information report.

Aspect 9: The method of any of aspects 1 through 8, wherein receiving the control signaling comprises: receiving, in a physical downlink control channel, a downlink control information message indicating the PMI, the RI, and an identifier of a subset of transmit antennas from the at least eight transmit antennas for the uplink transmission, wherein transmitting the uplink transmission is based at least in part on the subset of transmit antennas.

Aspect 10: A method for wireless communication at a base station, comprising: selecting, based at least in part on one or more reference signals received from a UE, a PMI and a RI, the PMI and the RI being based at least in part on the UE having at least eight transmit antennas and based at least in part on a phase difference between different subsets of transmit antennas of the at least eight transmit antennas; transmitting, to the UE, control signaling indicating the PMI and the RI; and receiving, from the UE, an uplink transmission configured based at least in part on the PMI and the RI.

Aspect 11: The method of aspect 10, further comprising: decoding, based at least in part on the at least eight transmit antennas, the uplink transmission based at least in part on a householder matrix that is at least eight-by-eight, wherein the PMI and the RI being based at least in part on the householder matrix.

Aspect 12: The method of any of aspects 10 through 11, further comprising: determining a co-phasing parameter for each of a plurality of different subsets of transmit antennas of the at least eight transmit antennas; and decoding the uplink transmission based at least in part on a first householder matrix for a first subset of the at least eight transmit antennas and a second householder matrix for a second subset of the at least eight transmit antennas, wherein the PMI, the RI, or both, are based at least in part on the first householder matrix and the second householder matrix and the first householder matrix and the second householder matrix are based at least in part on the co-phasing parameter of the first subset and the second subset.

Aspect 13: The method of any of aspects 10 through 12, further comprising: determining one or more per-layer co-phasing parameters for each of a plurality of different subsets of transmit antennas of the at least eight transmit antennas; and decoding the uplink transmission based at least in part on a first householder matrix for a first subset of the at least eight transmit antennas and a second householder matrix for a second subset of the at least eight transmit antennas, wherein the PMI, the RI, or both, are based at least in part on the first householder matrix and the second householder matrix and the first householder matrix and the second householder matrix are based at least in part on the one or more per-layer co-phasing parameters of the first subset and the second subset.

Aspect 14: The method of any of aspects 10 through 13, further comprising: decoding the uplink transmission based at least in part on a first codebook for the uplink transmission that comprises a first codebook subset restriction associated with non-coherent subsets of transmit antennas of the at least eight transmit antennas, a second codebook for the uplink transmission that comprises a second codebook subset restriction associated with partially coherent subsets of transmit antennas of the at least eight transmit antennas, or a third codebook for the uplink transmission that comprises a third codebook subset restriction associated with fully coherent subsets of transmit antennas of the at least eight transmit antennas.

Aspect 15: The method of any of aspects 10 through 14, further comprising: decoding the uplink transmission based at least in part on a single codebook for the uplink transmission that comprises at least one of a first codebook subset restriction associated with at least one of non-coherent subsets of transmit antennas, partially coherent subsets of transmit antennas, or fully coherent subsets of transmit antennas, of the at least eight transmit antennas.

Aspect 16: The method of any of aspects 10 through 15, wherein transmitting the control signaling comprises: transmitting, in a first physical downlink control channel, a first downlink control information message indicating the RI, an upper PMI and a lower PMI for the uplink transmission, wherein the PMI is based at least in part on the upper PMI and the lower PMI; and transmitting, in a second physical downlink control channel, the first downlink control information message and an indication of a co-phasing index between different subsets of transmit antennas of the at least eight transmit antennas.

Aspect 17: The method of aspect 16, wherein the indication of the co-phasing index is transmitted in the first downlink control information message, in a medium access control-control element, or in a channel state information report.

Aspect 18: The method of any of aspects 10 through 17, wherein transmitting the control signaling comprises: transmitting, in a physical downlink control channel, a downlink control information message indicating the PMI, the RI, and an identifier of a subset of transmit antennas from the at least transmit antennas, for the uplink transmission, wherein receiving the uplink transmission is based at least in part on the subset of transmit antennas.

Aspect 19: An apparatus for wireless communication at a UE, comprising a processor; memory coupled with the processor; and instructions stored in the memory and executable by the processor to cause the apparatus to perform a method of any of aspects 1 through 9.

Aspect 20: An apparatus for wireless communication at a UE, comprising at least one means for performing a method of any of aspects 1 through 9.

Aspect 21: A non-transitory computer-readable medium storing code for wireless communication at a UE, the code comprising instructions executable by a processor to perform a method of any of aspects 1 through 9.

Aspect 22: An apparatus for wireless communication at a base station, comprising a processor; memory coupled with the processor; and instructions stored in the memory and executable by the processor to cause the apparatus to perform a method of any of aspects 10 through 18.

Aspect 23: An apparatus for wireless communication at a base station, comprising at least one means for performing a method of any of aspects 10 through 18.

Aspect 24: A non-transitory computer-readable medium storing code for wireless communication at a base station, the code comprising instructions executable by a processor to perform a method of any of aspects 10 through 18.

It may be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (for example a combination of a DSP and a microprocessor, multiple microprocessors, microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc in which disks usually reproduce data magnetically, while discs reproduce data optically with lasers. Combinations of the above are also included within the scope of computer-readable media.

As used herein, including in the claims, “or” as used in a list of items (for example a list of items prefaced by a phrase such as “at least one of” or “one or more of”) indicates an inclusive list such that, for example, a list of at least one of A, B, or C means A or B or C or AB or AC or BC or ABC (in other words, A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, “determining” can include calculating, computing, processing, deriving, investigating, looking up (such as via looking up in a table, a database or another data structure), and ascertaining. Also, “determining” can include receiving (such as receiving information), accessing (such as accessing data in a memory). Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
transmitting, to a base station, one or more reference signals over a channel;
receiving, from the base station based at least in part on transmitting the one or more reference signals, control signaling indicating a precoding matrix indicator and a rank indicator, the precoding matrix indicator and the rank indicator being based at least in part on the UE having at least eight transmit antennas and based at least in part on a phase difference between different subsets of transmit antennas of the at least eight transmit antennas; and
transmitting, to the base station, an uplink transmission configured according to the precoding matrix indicator and the rank indicator.

2. The method of claim 1, further comprising determining, based at least in part on the at least eight transmit antennas, a householder matrix that is at least eight-by-eight for the uplink transmission, the precoding matrix indicator and the rank indicator being based at least in part on the householder matrix.

3. The method of claim 1, further comprising:
determining a co-phasing parameter for each of a plurality of different subsets of transmit antennas of the at least eight transmit antennas; and
determining a first householder matrix for a first subset of the at least eight transmit antennas and a second householder matrix for a second subset of the at least eight transmit antennas, wherein the precoding matrix indicator, the rank indicator, or both, are based at least in part on the first householder matrix and the second householder matrix and based at least in part on the co-phasing parameter of the first subset and the second subset.

4. The method of claim 1, further comprising:
determining one or more per-layer co-phasing parameters for each of a plurality of different subsets of transmit antennas of the at least eight transmit antennas; and
determining a first householder matrix for a first subset of the at least eight transmit antennas and a second householder matrix for a second subset of the at least eight transmit antennas, wherein the precoding matrix indicator, the rank indicator, or both, are based at least in part on the first householder matrix and the second householder matrix and are based at least in part on the one or more per-layer co-phasing parameters of the first subset and the second subset.

5. The method of claim 1, further comprising:
determining a first codebook for the uplink transmission that comprises a first codebook subset restriction associated with non-coherent subsets of transmit antennas of the at least eight transmit antennas;
determining a second codebook for the uplink transmission that comprises a second codebook subset restriction associated with partially coherent subsets of transmit antennas of the at least eight transmit antennas; and
determining a third codebook for the uplink transmission that comprises a third codebook subset restriction associated with fully coherent subsets of transmit antennas of the at least eight transmit antennas.

6. The method of claim 1, further comprising determining a single codebook for the uplink transmission that comprises a first codebook subset restriction associated with at least one of non-coherent subsets of transmit antennas, partially coherent subsets of transmit antennas, or fully coherent subsets of transmit antennas, of the at least eight transmit antennas.

7. The method of claim 1, wherein receiving the control signaling comprises:
receiving, in a first physical downlink control channel, a first downlink control information message indicating the rank indicator, an upper precoding matrix indicator and a lower precoding matrix indicator for the uplink transmission, wherein the precoding matrix indicator is based at least in part on the upper precoding matrix indicator and the lower precoding matrix indicator; and
receiving, in a second physical downlink control channel, the first downlink control information message and an indication of a co-phasing index between different subsets of transmit antennas of the at least eight transmit antennas.

8. The method of claim 7, wherein the indication of the co-phasing index is received in the first downlink control information message, in a medium access control-control element, or in a channel state information report.

9. The method of claim 1, wherein receiving the control signaling comprises receiving, in a physical downlink control channel, a downlink control information message indicating the precoding matrix indicator, the rank indicator, and an identifier of a subset of transmit antennas from the at least eight transmit antennas for the uplink transmission, wherein transmitting the uplink transmission is based at least in part on the subset of transmit antennas.

10. A method for wireless communication at a base station, comprising:
selecting, based at least in part on one or more reference signals received from a user equipment (UE), a precoding matrix indicator and a rank indicator, the precoding matrix indicator and the rank indicator being based at least in part on the UE having at least eight transmit antennas and based at least in part on a phase difference between different subsets of transmit antennas of the at least eight transmit antennas;
transmitting, to the UE, control signaling indicating the precoding matrix indicator and the rank indicator; and
receiving, from the UE, an uplink transmission configured based at least in part on the precoding matrix indicator and the rank indicator.

11. The method of claim 10, further comprising decoding, based at least in part on the at least eight transmit antennas, the uplink transmission based at least in part on a householder matrix that is at least eight-by-eight, wherein the precoding matrix indicator and the rank indicator being based at least in part on the householder matrix.

12. The method of claim 10, further comprising:
determining a co-phasing parameter for each of a plurality of different subsets of transmit antennas of the at least eight transmit antennas; and
decoding the uplink transmission based at least in part on a first householder matrix for a first subset of the at least eight transmit antennas and a second householder matrix for a second subset of the at least eight transmit antennas, wherein the precoding matrix indicator, the rank indicator, or both, are based at least in part on the first householder matrix and the second householder matrix and the first householder matrix and the second householder matrix are based at least in part on the co-phasing parameter of the first subset and the second subset.

13. The method of claim 10, further comprising:
determining one or more per-layer co-phasing parameters for each of a plurality of different subsets of transmit antennas of the at least eight transmit antennas; and
decoding the uplink transmission based at least in part on a first householder matrix for a first subset of the at least eight transmit antennas and a second householder matrix for a second subset of the at least eight transmit antennas, wherein the precoding matrix indicator, the rank indicator, or both, are based at least in part on the first householder matrix and the second householder matrix and the first householder matrix and the second householder matrix are based at least in part on the one or more per-layer co-phasing parameters of the first subset and the second subset.

14. The method of claim 10, further comprising decoding the uplink transmission based at least in part on a first codebook for the uplink transmission that comprises a first codebook subset restriction associated with non-coherent subsets of transmit antennas of the at least eight transmit antennas, a second codebook for the uplink transmission that comprises a second codebook subset restriction associated with partially coherent subsets of transmit antennas of the at least eight transmit antennas, or a third codebook for the uplink transmission that comprises a third codebook subset restriction associated with fully coherent subsets of transmit antennas of the at least eight transmit antennas.

15. The method of claim 10, further comprising decoding the uplink transmission based at least in part on a single codebook for the uplink transmission that comprises at least one of a first codebook subset restriction associated with at least one of non-coherent subsets of transmit antennas, partially coherent subsets of transmit antennas, or fully coherent subsets of transmit antennas, of the at least eight transmit antennas.

16. The method of claim 10, wherein transmitting the control signaling comprises:
transmitting, in a first physical downlink control channel, a first downlink control information message indicating the rank indicator, an upper precoding matrix indicator and a lower precoding matrix indicator for the uplink transmission, wherein the precoding matrix indicator is based at least in part on the upper precoding matrix indicator and the lower precoding matrix indicator; and
transmitting, in a second physical downlink control channel, the first downlink control information message and an indication of a co-phasing index between different subsets of transmit antennas of the at least eight transmit antennas.

17. The method of claim 16, wherein the indication of the co-phasing index is transmitted in the first downlink control information message, in a medium access control-control element, or in a channel state information report.

18. The method of claim 10, wherein transmitting the control signaling comprises transmitting, in a physical downlink control channel, a downlink control information message indicating the precoding matrix indicator, the rank indicator, and an identifier of a subset of transmit antennas from the at least transmit antennas, for the uplink transmission, wherein receiving the uplink transmission is based at least in part on the subset of transmit antennas.

19. An apparatus for wireless communication at a user equipment (UE), comprising:
a processor;
memory coupled with the processor; and
instructions stored in the memory and executable by the processor to cause the apparatus to:
transmit, to a base station, one or more reference signals over a channel;
receive, from the base station based at least in part on transmitting the one or more reference signals, control signaling indicating a precoding matrix indicator and a rank indicator, the precoding matrix indicator and the rank indicator being based at least in part on the UE having at least eight transmit antennas and based at least in part on a phase difference between different subsets of transmit antennas of the at least eight transmit antennas; and
transmit, to the base station, an uplink transmission configured according to the precoding matrix indicator and the rank indicator.

20. The apparatus of claim 19, wherein the instructions are further executable by the processor to cause the apparatus to determine, based at least in part on the at least eight transmit antennas, a householder matrix that is at least eight-by-eight for the uplink transmission, the precoding matrix indicator and the rank indicator being based at least in part on the householder matrix.

21. The apparatus of claim 19, wherein the instructions are further executable by the processor to cause the apparatus to:
determine a co-phasing parameter for each of a plurality of different subsets of transmit antennas of the at least eight transmit antennas; and
determine a first householder matrix for a first subset of the at least eight transmit antennas and a second householder matrix for a second subset of the at least eight transmit antennas, wherein the precoding matrix indicator, the rank indicator, or both, are based at least in part on the first householder matrix and the second householder matrix and based at least in part on the co-phasing parameter of the first subset and the second subset.

22. The apparatus of claim 19, wherein the instructions are further executable by the processor to cause the apparatus to:
determine one or more per-layer co-phasing parameters for each of a plurality of different subsets of transmit antennas of the at least eight transmit antennas; and
determine a first householder matrix for a first subset of the at least eight transmit antennas and a second householder matrix for a second subset of the at least eight transmit antennas, wherein the precoding matrix indicator, the rank indicator, or both, are based at least in part on the first householder matrix and the second householder matrix are based at least in part on the one or more per-layer co-phasing parameters of the first subset and the second subset.

23. The apparatus of claim 19, wherein the instructions are further executable by the processor to cause the apparatus to:
determine a first codebook for the uplink transmission that comprises a first codebook subset restriction associated with non-coherent subsets of transmit antennas of the at least eight transmit antennas;
determine a second codebook for the uplink transmission that comprises a second codebook subset restriction associated with partially coherent subsets of transmit antennas of the at least eight transmit antennas; and
determine a third codebook for the uplink transmission that comprises a third codebook subset restriction associated with fully coherent subsets of transmit antennas of the at least eight transmit antennas.

24. The apparatus of claim 19, wherein the instructions are further executable by the processor to cause the apparatus to determine a single codebook for the uplink transmission that comprises a first codebook subset restriction associated with at least one of non-coherent subsets of transmit antennas, partially coherent subsets of transmit antennas, or fully coherent subsets of transmit antennas, of the at least eight transmit antennas.

25. An apparatus for wireless communication at a base station, comprising:
a processor;
memory coupled with the processor; and
instructions stored in the memory and executable by the processor to cause the apparatus to:
select, based at least in part on one or more reference signals received from a user equipment (UE), a precoding matrix indicator and a rank indicator, the precoding matrix indicator and the rank indicator being based at least in part on the UE having at least eight transmit antennas and based at least in part on a phase difference between different subsets of transmit antennas of the at least eight transmit antennas;
transmit, to the UE, control signaling indicating the precoding matrix indicator and the rank indicator; and
receive, from the UE, an uplink transmission configured based at least in part on the precoding matrix indicator and the rank indicator.

26. The apparatus of claim 25, wherein the instructions are further executable by the processor to cause the apparatus to decode, based at least in part on the at least eight transmit antennas, the uplink transmission based at least in part on a householder matrix that is at least eight-by-eight, wherein the precoding matrix indicator and the rank indicator being based at least in part on the householder matrix.

27. The apparatus of claim 25, wherein the instructions are further executable by the processor to cause the apparatus to:
determine a co-phasing parameter for each of a plurality of different subsets of transmit antennas of the at least eight transmit antennas; and
decode the uplink transmission based at least in part on a first householder matrix for a first subset of the at least eight transmit antennas and a second householder matrix for a second subset of the at least eight transmit antennas, wherein the precoding matrix indicator, the rank indicator, or both, are based at least in part on the first householder matrix and the second householder matrix and the first householder matrix and the second householder matrix are based at least in part on the co-phasing parameter of the first subset and the second subset.

28. The apparatus of claim 25, wherein the instructions are further executable by the processor to cause the apparatus to:
determine one or more per-layer co-phasing parameters for each of a plurality of different subsets transmit antennas of the at least eight transmit antennas; and
decode the uplink transmission based at least in part on a first householder matrix for a first subset of the at least eight transmit antennas and a second householder matrix for a second subset of the at least eight transmit antennas, wherein the precoding matrix indicator, the rank indicator, or both, are based at least in part on the first householder matrix and the second householder matrix and the first householder matrix and the second householder matrix are based at least in part on the one or more per-layer co-phasing parameters of the first subset and the second subset.

29. The apparatus of claim 25, wherein the instructions are further executable by the processor to cause the apparatus to decode the uplink transmission based at least in part on a first codebook for the uplink transmission that comprises a first codebook subset restriction associated with non-coherent subsets of transmit antennas of the at least eight transmit antennas, a second codebook for the uplink transmission that comprises a second codebook subset restriction associated with partially coherent subsets of transmit antennas of the at least eight transmit antennas, or a third codebook for the uplink transmission that comprises a third codebook subset restriction associated with fully coherent subsets of transmit antennas of the at least eight transmit antennas.

30. The apparatus of claim 25, wherein the instructions are further executable by the processor to cause the apparatus to decode the uplink transmission based at least in part on a single codebook for the uplink transmission that comprises at least one of a first codebook subset restriction associated with at least one of non-coherent subsets of transmit antennas, partially coherent subsets of transmit antennas, or fully coherent subsets of transmit antennas, of the at least eight transmit antennas.
